(19) United States
(12) Patent Application Publication
(10) Pub. No.: US 2026/0303204 A1
(43) Pub. Date: Oct. 1, 2026

(54) OPTICAL COMMUNICATIONS CONTROLLER AND OPTICAL COMMUNICATIONS SYSTEM

(71) Applicant: 1FINITY Inc., Kawasaki-shi (JP)

(72) Inventor: Kazutomo FUJIYAMA, Kawasaki (JP)

(73) Assignee: 1FINITY Inc., Kawasaki-shi (JP)

(21) Appl. No.: 19/571,096

(22) Filed: Mar. 18, 2026

(30) Foreign Application Priority Data
Mar. 31, 2025 (JP) 2025-058455

(51) Int. Cl. H04B 10/038

(52) U.S. Cl. CPC H04B 10/038

(57) ABSTRACT

An optical communications controller for managing and controlling multiple devices under control of an optical transmission network, the optical communications controller has a controller configured to: obtain through a different transmission path different from a transmission path of a primary signal, a control signal including a state of each of the plurality of devices and a transmission path state; search for an alternative communicable path and obtain the control signal using the alternative path when the control signal cannot be obtained; and continue management control of the optical transmission network.

### CROSS REFERENCE TO RELATED APPLICATIONS

This application is based upon and claims the benefit of priority of the prior Japanese Patent Application No. 2025-058455, filed on Mar. 31, 2025, the entire contents of which are incorporated herein by reference.

### FIELD

Embodiments discussed herein relate to an optical communications controller and an optical communications system.

### BACKGROUND

The concept of Innovative Optical and Wireless Network (IWON) includes an All Photonics Network (the APN) in which the transceivers of the nodes and the network all transmit light. An Optical Supervisor Channel (OSC) signal is used to monitor the state of a primary signal transmitted between transceivers of nodes.

As a technique related to monitoring the state of an optical transmission network, for example, there is a technique in which a regular optical line and a backup optical line are provided, and when a fault in the regular optical line is detected using a test optical signal that is periodically transmitted, an optical signal is bypass-relayed between an upstream backup optical line and a downstream regular optical line, and transmission and reception of the optical signal are maintained. In addition, there is a technique in which an amplifier node provided between switching nodes detects an extinction (LOS) state of a signal by an OSC and performs a switching operation of bypassing a failed switching node. In addition, there is a technique in which, when an abnormality is detected in a primary network node, an optical switch switches connection from the primary network node to a standby network node and performs communication backup using the standby network node. In addition, there is a technique for suppressing an influence of an operation against an intention of a communications carrier by receiving a user operation of a changeable setting for a transceiver through authentication. For example, refer to Japanese Laid-Open Patent Publication No. 2023-057111, U.S. Pat. No. 7,113,698, U.S. Patent Application Publication No. 2017/0078015, and International Publication No. WO 2024/142140.

### SUMMARY

According to an aspect of an embodiment, an optical communications controller for managing and controlling multiple devices under control of an optical transmission network, the optical communications controller has a controller configured to: obtain through a different transmission path different from a transmission path of a primary signal, a control signal including a state of each of the plurality of devices and a transmission path state; search for an alternative communicable path and obtain the control signal using the alternative path when the control signal cannot be obtained; and continue management control of the optical transmission network.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 is a diagram depicting an example of a network configuration of an optical communications system that includes an optical communications controller according to an embodiment.

FIG. 2 is an explanatory diagram of an example of connection work of a transmission path of a primary signal according to a background art.

FIG. 3 is an explanatory diagram of an example of connection work of a transmission path of a primary signal according to a background art.

FIG. 4 is a diagram depicting an example of transmission of a primary signal and a control signal according to the embodiment.

FIG. 5 is an explanatory diagram of an example of information managed by an APN-C.

FIG. 6 is a table depicting an example of monitoring control information.

FIG. 7 is a diagram depicting an E2E connection state of APN-Ts.

FIG. 8 is a diagram depicting an example of a hardware configuration of a controller of the APN-C.

FIG. 9A is a flowchart depicting processing contents when the APN-T is installed.

FIG. 9B is a sequence diagram of information transmitted and received between devices of the APN network corresponding to the processing contents depicted in FIG. 9A.

FIG. 10A is a flowchart depicting processing contents when a primary signal A is communicated between the APN-Ts.

FIG. 10B is a sequence diagram of information transmitted and received between the devices of the APN network corresponding to the processing content depicted in FIG. 10A.

FIG. 11 is a diagram depicting a state when a control signal failure occurs.

FIG. 12 is a diagram depicting an alternative path corresponding to a failure occurrence location of the control signal.

FIG. 13 is a diagram depicting an alternative path corresponding to a failure occurrence location of the control signal.

FIG. 14A is a diagram depicting an example of a path switching process of the control signal when a failure of the control signal occurs.

FIG. 14B is a diagram depicting an example of a path switching process of the control signal when a failure of the control signal occurs.

FIG. 15A is a diagram depicting an example of a path switching process of the control signal when a failure of the control signal occurs.

FIG. 15B is a diagram depicting an example of a path switching process of the control signal when a failure of the control signal occurs.

FIG. 16 is an explanatory diagram of an example of data compression of the control signal superimposed on the primary signal.

FIG. 17 is a flowchart depicting a processing example of the APN-C.

FIG. 18 is a flowchart depicting another example of processing by the APN-C.

FIG. 19 is a diagram depicting another example of configuration of a transmission line according to the embodiment.

FIG. 20 is a diagram depicting a first configuration example of the APN-Ts.

FIG. 21A is a flowchart depicting processing contents when interruption of the control signal occurs at a point X4.

FIG. 21B is a sequence diagram of information transmitted and received between the devices corresponding to the processing contents depicted in FIG. 21A.

FIG. 22 is a diagram depicting a second configuration example of the APN-T.

FIG. 23A is a flowchart depicting processing contents at the time of failure of an APN-T(1) child_d (402d).

FIG. 23B is a sequence diagram of information transmitted and received between devices, corresponding to the processing contents depicted in FIG. 23A.

FIG. 24 is a diagram depicting a third configuration example of the APN-T.

FIG. 25 is a diagram depicting a failure in the third configuration example of the APN-T.

FIG. 26A is a flowchart depicting processing contents at the time of failure of the APN-T(1) child_d (402d).

FIG. 26B is a sequence diagram of information transmitted and received between devices corresponding to the processing contents depicted in FIG. 26A.

FIG. 27 is a diagram depicting a first connection configuration example of multiple APN-Ts and an APN-G.

FIG. 28 is a diagram depicting an example of a path switching process at the time of a failure in the first connection configuration example of multiple APN-Ts and an APN-G.

FIG. 29 is a diagram depicting a second connection configuration example of multiple APN-Ts and an APN-G.

FIG. 30 is a diagram depicting an example of a path switching process at the time of a failure in the second connection configuration example of multiple APN-Ts and an APN-G.

FIG. 31 is a configuration example of another APN network and example of a path switching process at the time of failure.

### DESCRIPTION OF EMBODIMENTS

First, problems associated with the conventional techniques are discussed. Conventionally, since the OSC signal is monitored by superimposing the OSC signal on the primary signal, it is not possible to correctly grasp the actual failure state that causes the OSC interruption. For example, it is impossible to distinguish and determine the state of a failure such as a failure of a device of a node, disconnection of a primary signal, or interruption of an OSC signal alone. In this case, every time the OSC is disconnected, a worker has to check the actual situation onsite where the failure has occurred to know the state of the failure, which makes operation complicated. As a result, conventionally, the optical communications controller (the APN-C) cannot correctly manage the state of each device under the control of the APN network or transmission paths, and cannot remotely control an appropriate countermeasure against the failure.

Embodiments of an optical communications controller and an optical communications system according to the present disclosure will be described in detail with reference to the drawings. An optical communications system according to an embodiment manages and controls each device on an optical transmission network. An APN network described in the embodiment is an example of an optical transmission network. The devices on the APN network include optical transceivers (APN-Ts), monitoring gateways (APN-Gs), and an optical communications controller (APN-C).

The APN-C of the embodiment manages and controls devices subordinate to the APN network. Through a transmission path different from the transmission path of a primary signal, the APN-C obtains a control signal that includes the states of the devices and the states of transmission paths. When the APN-C cannot obtain a control signal due to the occurrence of a failure at any one of the devices or on a transmission path, the APN-C obtains the control signal via another device by searching for a communicable alternative path, and continues the management control of the APN network.

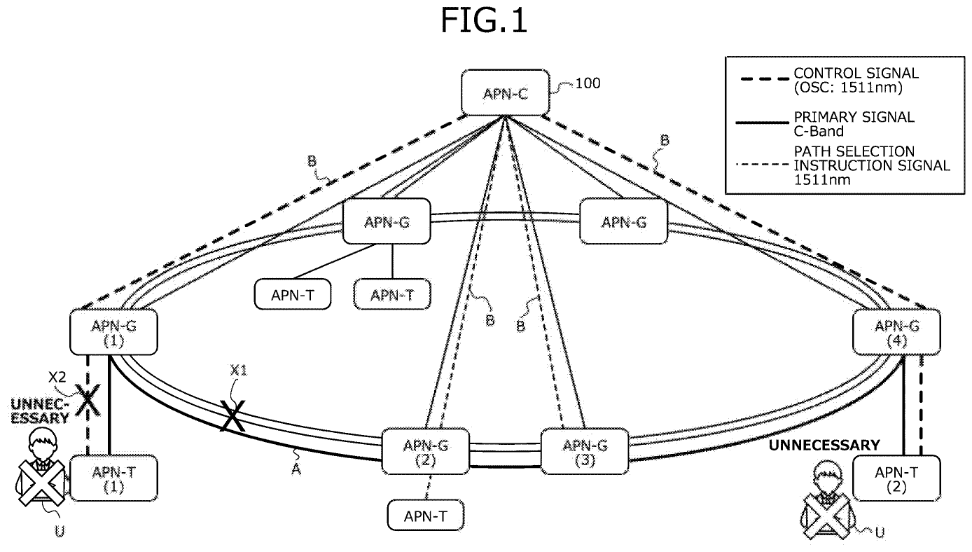

FIG. 1 is a diagram depicting an example of a network configuration of an optical communications system that includes an optical communications controller according to the embodiment. First, an overview of an overall configuration of the embodiment will be described with reference to FIG. 1. The APN-G is provided as multiple nodes on an optical network (the APN network) and relays and transmits a primary signal. The APN network depicted in FIG. 1 is an example of a ring network in which multiple the APN-Gs are connected in a ring shape. The APN-Ts are nodes connected to the APN-Gs and transmits (transmits and receives) a primary optical signal.

The APN-Ts are disposed as a node at an End-to-End (E2E) position on the APN network, that is, at a pair of terminal stations that optically transmit the primary signal. For example, the APN-T(1) at one end transmits the primary signal A via a transmission path (optical fiber) between the APN-T(1) and the APN-T(2), which is at the other end, via multiple the APN-Gs.

The optical communications controller (the APN-C) 100 manages and remotely controls the states of the devices of the entire optical network of the APN network including the APN-Ts and the APN-Gs and the transmission states of the transmission paths. Details of the information (data) managed by the APN-C will be described later. The APN-C monitors the transmission state of the primary signal A using a control signal B, and performs identification of a failure occurrence location on the transmission path of the primary signal A, bypass control of the transmission path for the primary signal A avoiding the failure occurrence location, and the like. The APN-C obtains the states of the devices and a transmission path between the APN-C and each device of the APN network using the control signal B (upstream), and performs control on each device obtained using the control signal B (downstream). In the embodiment, it is basically assumed that the upstream and downstream transmission paths of the control signal B are the same, but the upstream and downstream transmission paths of the control signal B may be different.

In the embodiment, the transmission path of the primary signal A and the transmission path of the control signal B are different paths. In the example depicted in FIG. 1, the transmission path of the primary signal A between the APN-T(1) and the APN-T(2) is the APN-T(1) to the APN-G(1) to the APN-G(2) to the APN-G(3) to the APN-G(4) to the APN-T(2).

On the other hand, the transmission path of the control signal B of the APN-T(1) obtained by the APN-C is the APN-T(1) to the APN-G(1) to the APN-C. The transmission path of the control signal B of the APN-T(2) obtained by the APN-C is the APN-T(2) to the APN-G(4) to the APN-C.

Without limitation hereto, the APN-C may also obtain the control signal B of the APN-T(1) and the APN-T(2) via another node disposed on the transmission path of the primary signal A, for example, the APN-G(2) or the APN-G(3).

The APN-C outputs a path selection signal to the APN-G(2) and the APN-G(3) disposed in the transmission path of primary signal A using the control signal B in order to set the transmission path of the primary signal A depicted in FIG. 1.

As the primary signal A and the control signal B, generally used wavelengths may be used. For example, the primary signal A has a predetermined band such as a C band or an L band, and the control signal B may use an OSC (1511 nm) different from the wavelength band of the primary signal A.

As described, in the embodiment, the transmission path of the primary signal A is different from the transmission path of the control signal B. Therefore, even when a failure (location X1) such as disconnection occurs on the transmission path of the primary signal A, the APN-C may obtain the control signal B through a transmission path different from the transmission path of the primary signal A. Based on the obtained control signal B, the APN-C continues to monitor each device through a transmission path that bypasses the location where the failure of the control signal B has occurred.

Although details will be described later, the APN-C integrally controls nodes (the APN-Gs and the APN-Ts) of the entire the APN network, and the control signal B may also be obtained by bypassing or the like.

According to the embodiment, even when a failure occurs on the transmission path of the control signal B, the APN-C may perform various types of control to prevent interruption of the transmission service of the primary signal A. For example, when the control signal B is interrupted at the point X2 in FIG. 1, the APN-C does not stop the communication of the primary signal A (maintains the transmission state as it is without performing bypass control or the like of the primary signal A) because the transmission state itself on the transmission path of the primary signal A has no problem. In this case, when the control signal B is not transmitted at the portion X2, the APN-T(1) may transmit the control signal B to the APN-C via another the APN-T, for example, the APN-T(2) on the opposite side by carrying the control signal B on the primary signal A. Examples of an occurrence of various failures and corresponding control examples will be described later.

According to the embodiment, it is possible to omit confirmation work by a worker U at the site (the APN-Ts or the like) at the time of path setting or failure occurrence, and it is possible to perform remote control at the APN-C.

Here, a technical background and associated problems will be described.

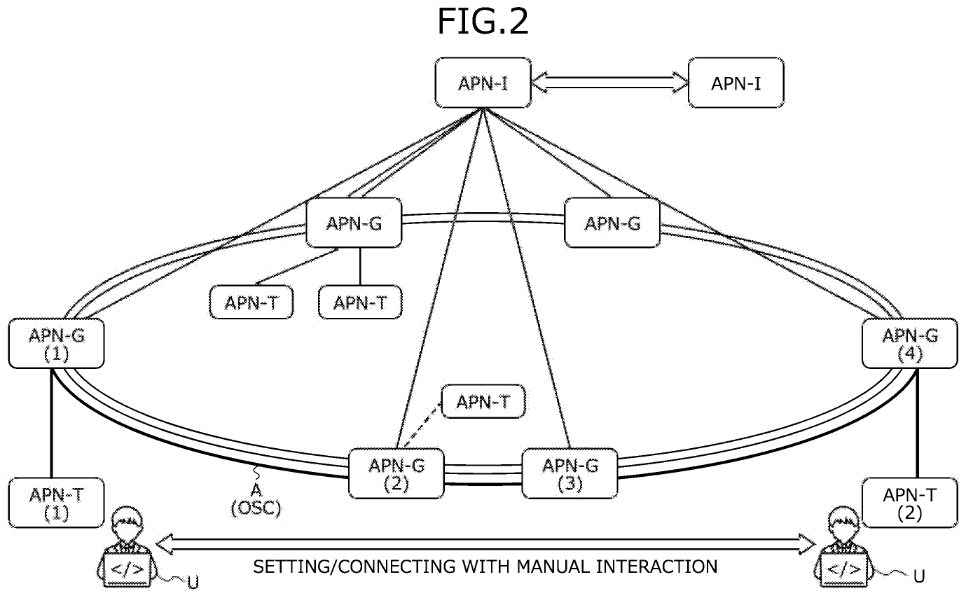

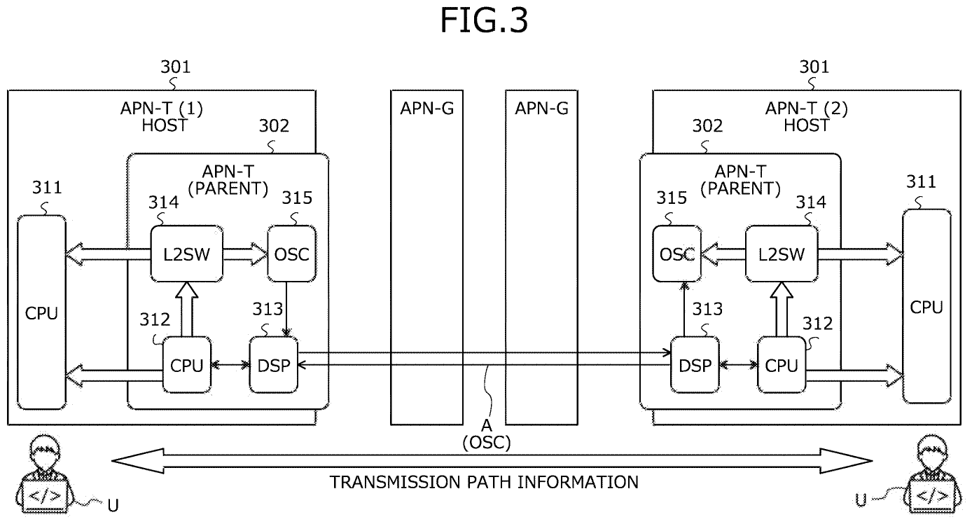

FIGS. 2 and 3 are explanatory diagrams of examples of connection work of a transmission path of a primary signal according to a background art. An interchange (the APN-I) is disposed in the APN network defined by the IWON depicted in FIG. 2. The APN-I does not perform control of the APN-T and performs only monitoring control based on OSC on the same transmission path as the primary signal A. In FIG. 2, in a case where the transmission path of the primary signal A is set in the same manner as in FIG. 1, it is necessary to place workers U at paired APN-T (the APN-T(1) and the APN-T(2)), respectively, and perform setting and connection work while the workers U manually communicate with each other, which takes time and effort.

FIG. 3 depicts an E2E connection state between the pair of APN-Ts depicted in FIG. 2. The APN-T(1) and the APN-T(2) have a configuration in which, for example, multiple parent modules 302 (only one module is depicted in FIG. 3) may be inserted into and removed from slots inside a host (shelf housing) 301.

A CPU 311 of a host 301 controls parent modules 302. Each parent module 302 includes a CPU 312, a digital signal processor (DSP) 313, a layer_2 switch (L2SW) 314, and an OSC unit 315. The CPU 312 controls the parent module 302. In terms of processing in the bidirectional transmission of the APN-T(1) on data transmission side, the DSP 313 transmits to the transmission path, a primary signal A obtained by converting an electric signal of transmission data into an optical signal. An optical DAC may be used as the DSP 313. The L2SW 314 controls packet transmission of the primary signal A, wavelength-multiplexes the OSC with the primary signal A, and transmits a wavelength-multiplexed signal. On the reception side of processing the data at the APN-T(2), the DSP 313, the L2SW 314, and the OSC unit 315 perform reception processing on the received primary signal A and perform monitoring control based on the OSC.

In the background art depicted in FIG. 3, it is necessary to place a worker U at each of the hosts 301 of the APN-T(1) and the APN-T(2) to perform E2E connection work. At this time, it is necessary for the workers U to perform the connection while confirming the transmission path information obtained in advance, the transmission path state at the time of the connection, and the like. In addition, each time a failure occurs in the connection due to a failure such as OSC disconnection, a worker U needs to perform on-site confirmation work.

On the other hand, in the embodiment, as depicted in FIG. 1, in the APN network of the IWON, through a transmission path different from that of the primary signal A, the APN-C obtains the control signal B by picking up the control signal B from the APN-T that transmits the primary signal A, and performs path setting and control when a failure occurs. In the embodiment, it is possible to omit the checking work by the worker U onsite (the APN-T or the like) at the time of connection of the transmission path and when a failure occurs, which are necessary in the background art, and the APN-C performs remote control of each node (the APN-Ts, the APN-Gs, or the like) of the APN network.

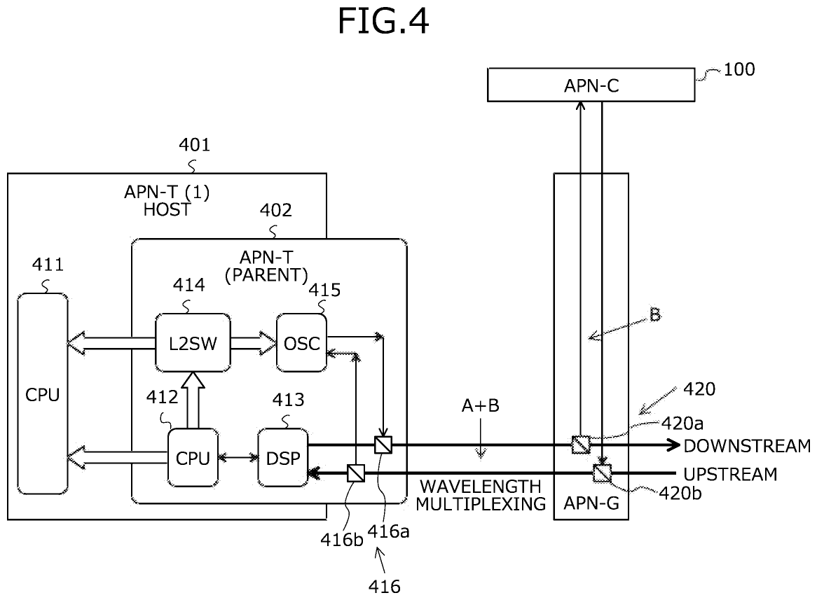

FIG. 4 is a diagram depicting an example of transmission of a primary signal and a control signal according to the embodiment. In the APN-T(1), similar to FIG. 3, the APN-T(1) of a host 401 includes a CPU 411. An APN-T(1) parent module 402 includes components (a CPU 412, a DSP 413, an L2SW 414, an OSC unit 415), and may be inserted in and removed from the host 401. Multiplexer/demultiplexers 416 are provided on downstream and upstream transmission paths of the primary signal transmitted and received by the DSP 413.

The term “parent” of the APN-T(1) parent module 402 indicates a module having the OSC unit 415 capable of communicating an OSC signal therein. As will be described later, the term “child” of an APN-T(1) child module indicates a module that does not have the OSC unit 415 capable of communicating an OSC signal therein.

In the transmission example depicted in FIG. 4, the multiplexer 416a transmits on the downstream transmission path, the optical signal (A+B) obtained by wavelength-multiplexing the primary signal output from the DSP 413 and the control signal B (OSC) output from the OSC unit 415. The multiplexer 416b demultiplexes wavelengths of an optical signal (A+B) received through the upstream transmission path, outputs the primary signal A to the DSP 413, and outputs the control signal B to the OSC unit 415.

Each of the APN-Gs includes multiplexer/demultiplexers 420 on the transmission paths of the primary signal A. The multiplexer 420a provided on the upstream transmission path transmits to the APN-C, the control signal B (OSC) wavelength-separated from the primary signal A. The multiplexer 420b provided on the downstream transmission path wavelength-multiplexes control signal B (OSC) output from the APN-C with the primary signal A and transmits the resulting signal to the APN-T(1) 401.

Thus, the APN-T(1) may transmit and receive the control signal B (OSC) to and from the APN-C via the APN-Gs. FIG. 4 is an example of transmission of the control signal B, and the control signal B between the APN-G and the APN-C may be transmitted not only by an optical signal but also by an electric signal. Furthermore, the OSC unit 415 of the APN-T(1) may transmit the control signal B between the APN-T(1) and the APN-C by an electric signal or an optical signal.

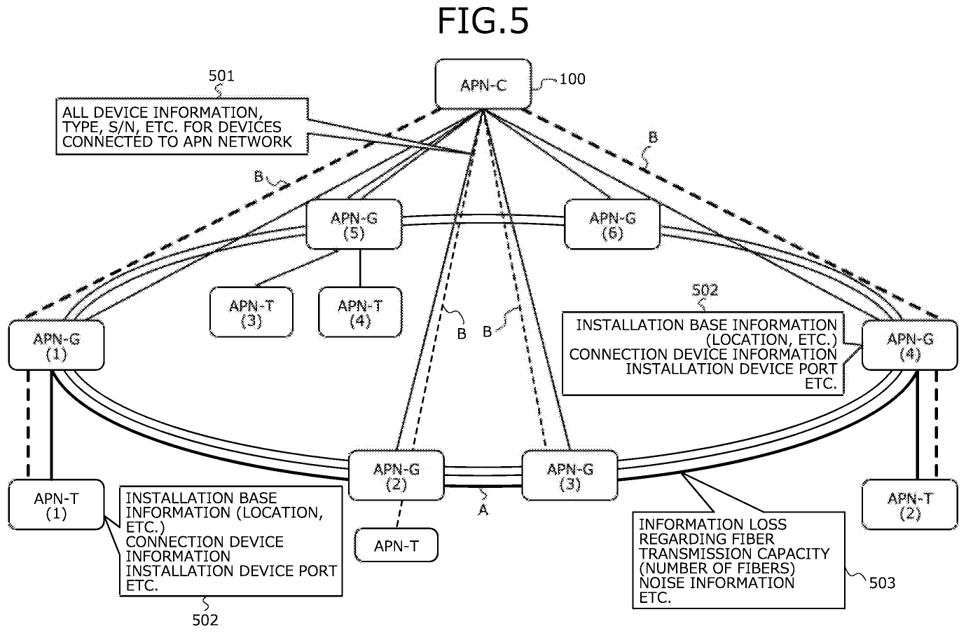

FIG. 5 is an explanatory diagram of an example of information managed by the APN-C. The APN-C obtains individual identification information 501, installation information 502, and information 503 concerning transmission paths (fibers) of all the devices connected to the APN network using the control signal B, records the information to a recording unit, and manages the information for controlling the devices. In the example depicted in FIG. 5, the devices controlled by the APN-C correspond to the APN-Ts and the APN-Gs.

The individual identification information 501 includes information such as the model and signal-to-noise ratio (S/N) of a device. The installation information 502 includes information concerning the device, such as an installation base (location or the like), a connected device, and an installation port. The information 503 concerning transmission paths (fibers) includes information such as the loss, transmission capacity (number of fibers), and noise state of the optical fibers between sites.

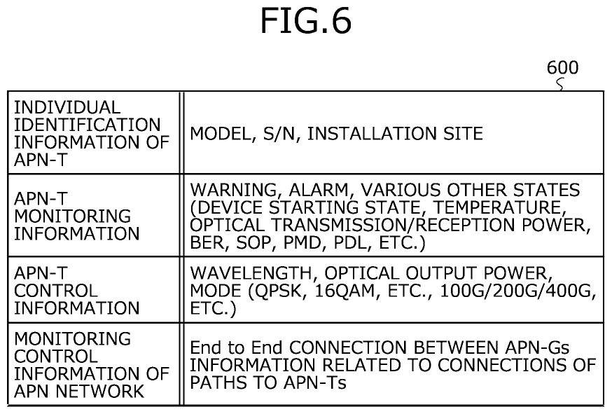

FIG. 6 is a table depicting an example of monitoring control information. The APN-C includes, as monitoring control information 600, individual identification information of the APN-Ts, monitoring information of the APN-Ts, control information of the APN-Ts, and monitoring control information of the APN network. The monitoring control information 600 includes information managed by the APN-C depicted in FIG. 5 and information at the time of the APN network operation.

The individual identification information of an APN-T includes information concerning the model, S/N, and installation location of the device. The monitoring information of an APN-T includes a monitoring alarm (Warning Alarm) and various other information (including information concerning device activation state, temperature, optical transmission/reception power, BER, SOP, PMD, PDL, and the like). BER is an abbreviation of Bit Error Rate, SOP is an abbreviation of State of Polarization, MD is an abbreviation of Polarization Mode Dispersion, and PDL is an abbreviation of Polarization Dependent Loss.

The control information of an APN-T includes a wavelength of optical transmission, optical output power, and an optical modulation mode (QPSK, 16QAM, or the like, 100G/200G/400G, or the like). The monitoring control information of the APN network includes path connection relationship information between the APN-Ts in E2E passing through the APN-Gs.

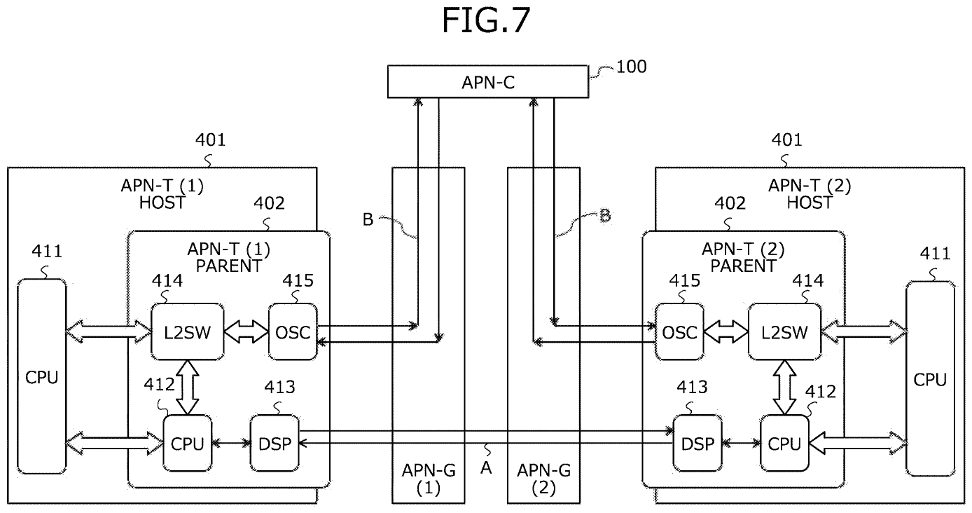

FIG. 7 is a diagram depicting an E2E connection state of the APN-Ts. Although the primary signal A and the control signal B may be transmitted in the example described in FIG. 4, the primary signal A and the control signal B are separately described in FIG. 7 and subsequent drawings for convenience. The APN-T(1) and the APN-T(2) connected E2E transmit the primary signal A through a transmission path via the APN-Gs. The control signal B is transmitted to the APN-C via the APN-Gs. The APN-C remotely controls the APN-T(1) and the APN-T(2) by obtaining the control signal B from the APN-T(1) and the APN-T(2) via the APN-Gs.

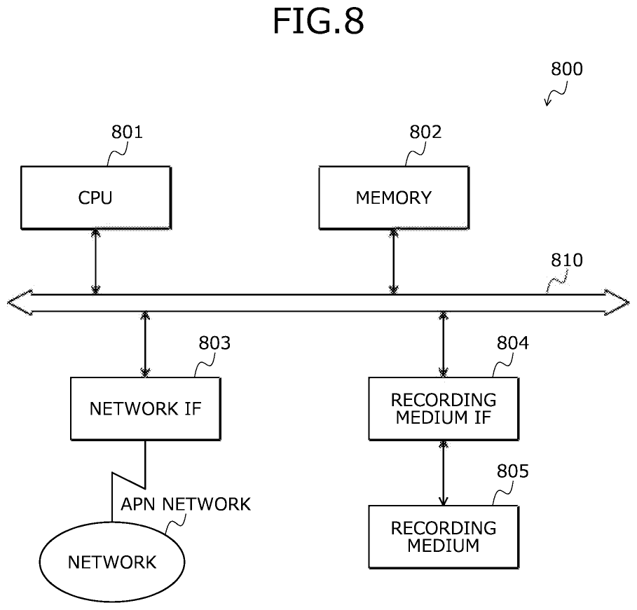

FIG. 8 is a diagram depicting an example of a hardware configuration of a controller of the APN-C. In the APN-C, control of the APN network may be implemented by, for example, hardware depicted in a controller 800 in FIG. 8.

The controller 800 includes a processor 801 such as a central processing unit (CPU), a memory 802, a network IF 803, a recording medium IF 804, and a recording medium 805. The components are connected to each other via a bus 810.

The processor 801 governs overall control of the controller 800. The processor 801 may have multiple cores. The memory 802 includes, for example, a read-only memory (ROM), a random access memory (RAM), and a flash ROM. Specifically, for example, the flash ROM stores therein a control program, the ROM stores therein an application program, and the RAM is used as a work area of the processor 801. A program stored in the memory 802 is loaded onto the processor 801, whereby the processor 801 executes encoded processes.

The network IF 803 serves as an interface between a network (the APN network) and the inside of the device, and controls the input and output of information.

The recording medium IF 804 controls the reading and writing of data with respect to the recording medium 805, under the control of the processor 801. The recording medium 805 stores therein data written thereto under the control of the recording medium IF 804.

In addition to the components described above, for example, an input device, a display, and the like may be connect to the controller 800 via an IF.

The processor 801 depicted in FIG. 8 obtains, for example, information from each device of the APN network and controls each device by executing a program. For example, the controller 800 obtains the information 501 to 503 and 600 depicted in FIGS. 5 and 6 from the devices connected to the network (the APN network) through the transmission paths of the control signal B. Then, the controller 800 controls each device through the transmission paths of the control signal B based on a monitoring control result.

Other devices (the APN-Ts and the APN-Gs) provided on the APN network also include a controller having a configuration similar to that of the controller 800 depicted in FIG. 8.

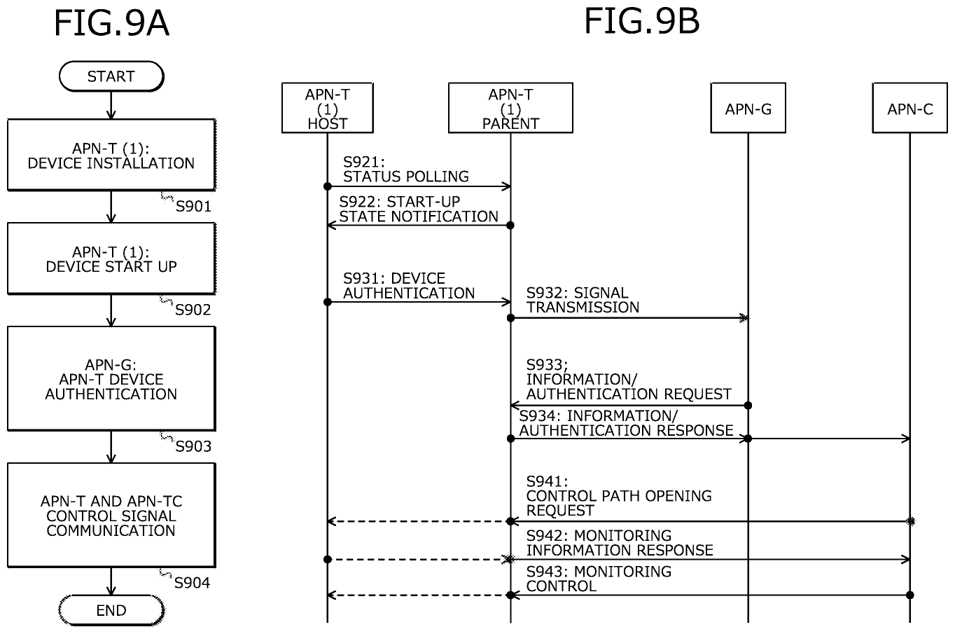

FIGS. 9A and 9B are diagrams depicting an example of processing when an APN-T is installed. FIG. 9A is a flowchart depicting processing contents when the APN-T is installed and FIG. 9B is a sequence diagram of information transmitted and received between devices of the APN network corresponding to the processing contents depicted in FIG. 9A. The processes depicted in FIGS. 9A and 9B are executed by the controller (the CPU 801 in FIG. 8) of each corresponding device.

As depicted in FIG. 9A, the APN-T is set (step S901). For example, it is assumed that a new the APN-T(1) parent (module) is installed in the APN-T(1) host. Next, the APN-T(1) activates the device (step S902). Next, the APN-G performs device authentication of the APN-T (step S903). Then, the control signal B is communicated between the APN-T and the APN-C (step S904), and the above processing for installation is ended.

The processing by each device will be described with reference to FIG. 9B. First, the installed APN-T(1) host transmits Status to the APN-T(1) parent by polling (step S921), and the APN-T(1) parent is activated according to the activation sequence and notifies the APN-T(1) host of the activation state (step S922).

Next, the APN-T(1) host performs device authentication of the APN-T(1) parent (step S931), and the APN-T(1) parent transmits the primary signal A to the APN-G (step S932). Next, the APN-G makes an information/authentication request to the APN-T(1) parent (step S933), and the APN-T(1) parent makes an information/authentication response to the APN-Gs using the control signal B (step S934). The APN-C obtains this information/authentication response.

Thereafter, the APN-C makes an OSC control path opening request to the APN-T(1) (step S941). The APN-T(1) host makes a monitoring control response to the APN-C by OSC (step S942). As a result, the APN-C thereafter performs monitoring control with respect to the APN-T(1). (step S943).

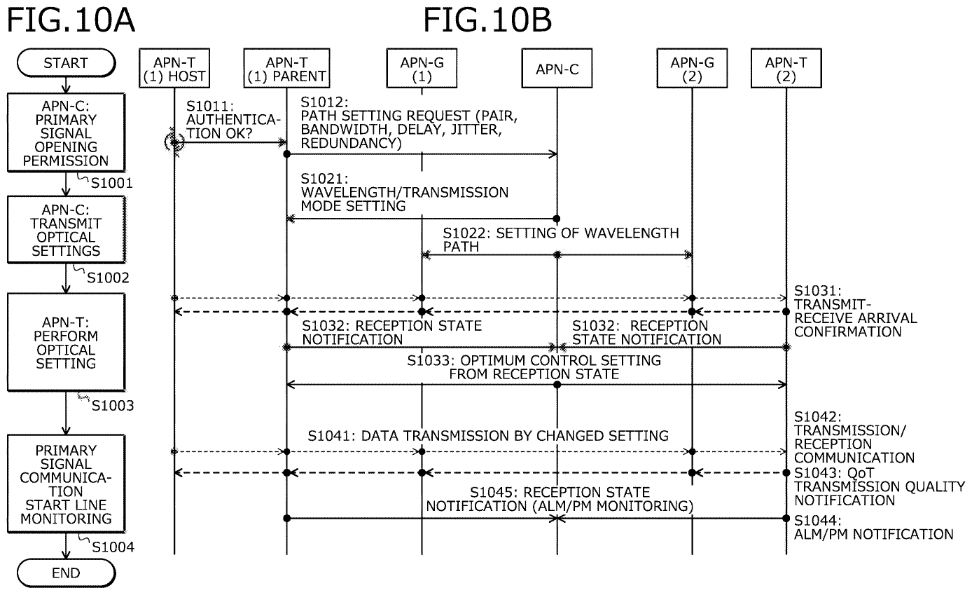

FIGS. 10A and 10B are diagrams depicting an example of processing when the primary signal is communicated in the APN network. After the processing depicted in FIGS. 9A and 9B, the devices on the APN network perform the processing depicted in FIGS. 10A and 10B. FIG. 10A is a flowchart depicting processing contents when the primary signal A is communicated between the APN-Ts, and FIG. 10B is a sequence diagram of information transmitted and received between the devices of the APN network corresponding to the processing content depicted in FIG. 10A.

As depicted in FIG. 10A, when the primary signal A is communicated, the APN-C first performs a process of permitting opening of the primary signal A between the APN-T(1) and the APN-T(2) (step S1001). Next, the APN-C transmits an optical setting to the APN-T (step S1002). Next, the APN-T performs the optical setting (step S1003). Then, the APN-T communicates the primary signal A, and the APN-C starts line monitoring (step S1004).

First, the APN-T(1) host authenticates the APN-T(1) parent (step S1011). When the authentication is OK, the APN-T(1) parent requests the APN-C to set a path using the control signal B (step S1012). The path setup request includes information such as the bandwidth, delay, jitter, and redundancy of the pair with the APN-T(2).

Next, the APN-C performs wavelength/transmission mode setting for the APN-T(1) using the control signal B (step S1021). The APN-C sets a wavelength path for the APN-G(1) and the APN-G(2) using the control signal B (step S1022).

Next, the APN-T(1) and the APN-T(2) for which the wavelength path has been set transmit and receive the primary signal A to and from each other (step S1031). At this time, the APN-T(1) and the APN-T(2) each notify the APN-C of the reception state of the primary signal A using the control signal B (step S1032). The APN-C performs optimum control setting for the APN-T(1) and the APN-T(2) based on the reception state notification (step S1033).

Next, the APN-T(1) transmits data to the APN-T(2) using the control signal B with the setting changed by the optimum control (step S1041), and performs transmission and reception communication between the APN-T(1) and the APN-T(2) (step S1042). The APN-T(2) notifies the APN-T(1) of transmission quality (QoT) using the control signal B (step S1043). The APN-T(1) and the APN-T(2) each perform a monitoring information (ALM/PM) notification process using the control signal B (step S1044), the APN-T(1) and the APN-T(2) notify the APN-C of the reception state of the monitoring information using the control signal B (step S1045), and the APN-C performs ALM/PM monitoring.

Next, an example of processing when a failure of the control signal B occurs on the APN network will be described.

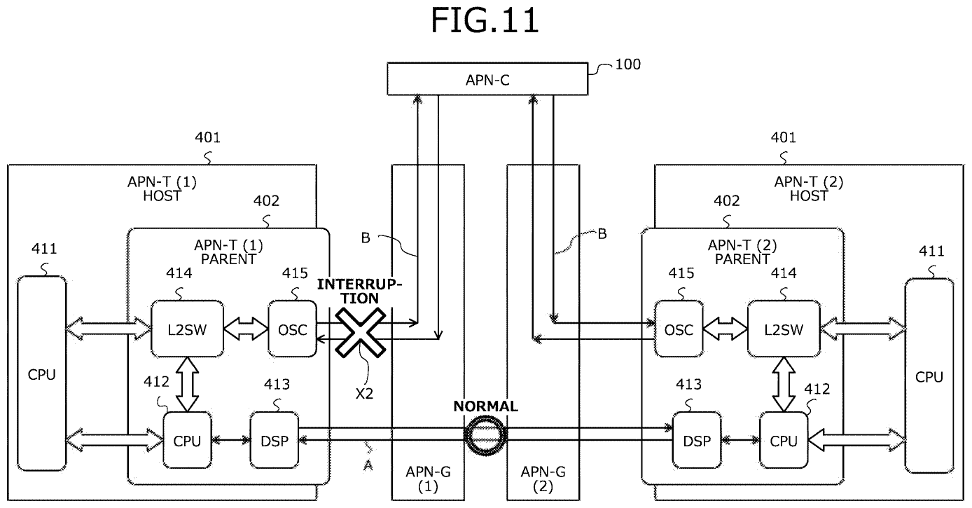

FIG. 11 is a diagram depicting a state when a control signal failure occurs. In the example depicted in FIG. 11, interruption of the control signal B occurs at a location X2 between the APN-T(1) and the APN-G(1). For example, it is assumed that a failure such as a failure in the OSC unit 415 occurs and the transmission of the control signal B (OSC) is stopped. Thus, the APN-C cannot communicate the control signal B with the APN-T(1). However, since the transmission of the primary signal A between the APN-T(1) and the APN-T(2) depicted in FIG. 11 has no problem and is normal, the APN-C does not stop the communication of the primary signal A.

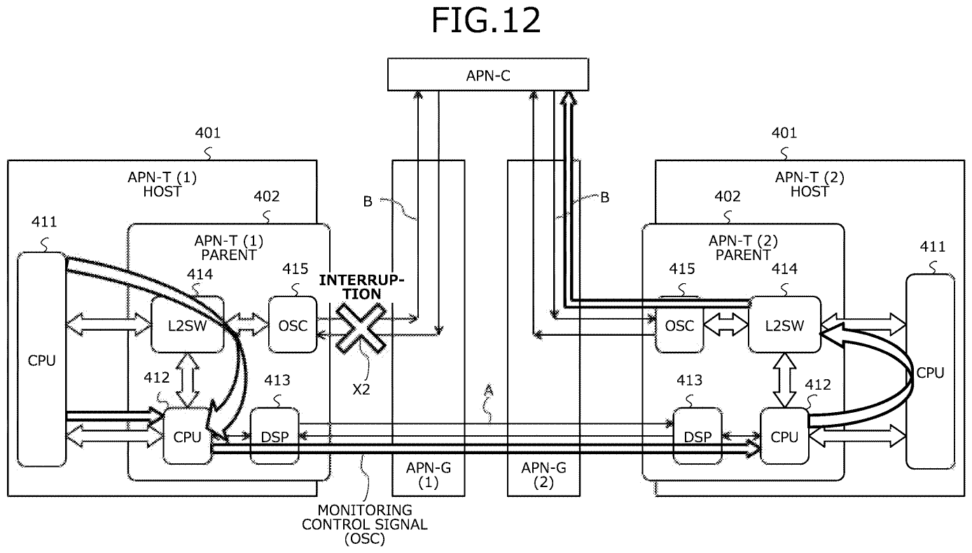

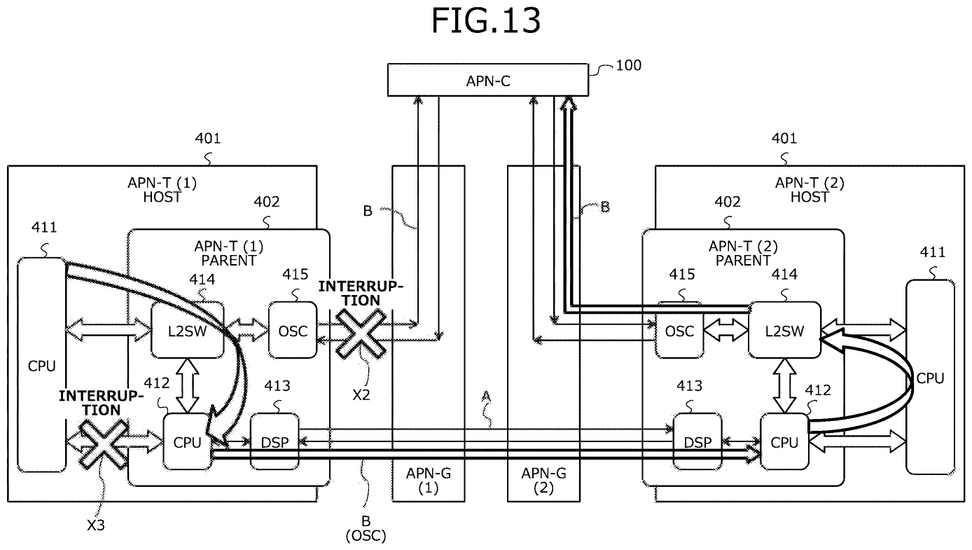

FIGS. 12 and 13 are diagrams depicting alternative paths corresponding to a failure occurrence location of a control signal. FIG. 12 depicts an alternative path corresponding to the interruption of the control signal B at the point X2 depicted in FIG. 11. In the example depicted in FIG. 12, without passing through location X2, the APN-T(1) is connected to the APN-C via the APN-T(2) on the opposite side by placing the control signal B (for example, OSC) in the overhead of the transmission path of the primary signal A.

In this case, the CPU 411 of the APN-T(1) host 401 outputs a control signal to the CPU 412 of the APN-T(1) parent 402, and the DSP 413 transmits the control signal to the APN-T(2) on the opposite side by placing the control signal in the overhead of the downstream primary signal A. The APN-T(2) extracts the control signal (OSC) from the received primary signal A by wavelength-demultiplexing, and transmits the control signal to the APN-C via the OSC unit 415.

By detouring the control signal B as described above, the control signal B may be transmitted to the APN-C via the APN-T(2) using the transmission path of the primary signal A even when an interruption of the control signal B occurs at the location X2. The APN-C may control the APN-T(1) in the transmission path of the upstream primary signal A of the bypass path.

FIG. 13 depicts a case where, in addition to the location X2, a disconnection further occurs at a location X3 between the CPU 411 of the APN-T(1) host 401 and the CPU 412 of the APN-T(1) parent 402 in the APN-T(1).

In the communication between the APN-T(1) host 401 and the APN-T(1) parent 402, the control signal B may be detoured and controlled even when either one of the direct access via the L2SW 414 and the direct access between the CPU 411 and the CPU 412 is interrupted. When the location X3 between one the CPU 411 and the CPU 412 depicted in FIG. 13 is disconnected, the CPU 411 may output the control signal B to the DSP 413 via the L2SW 414, and may transmit the control signal B to the APN-C via the opposing the APN-T(2).

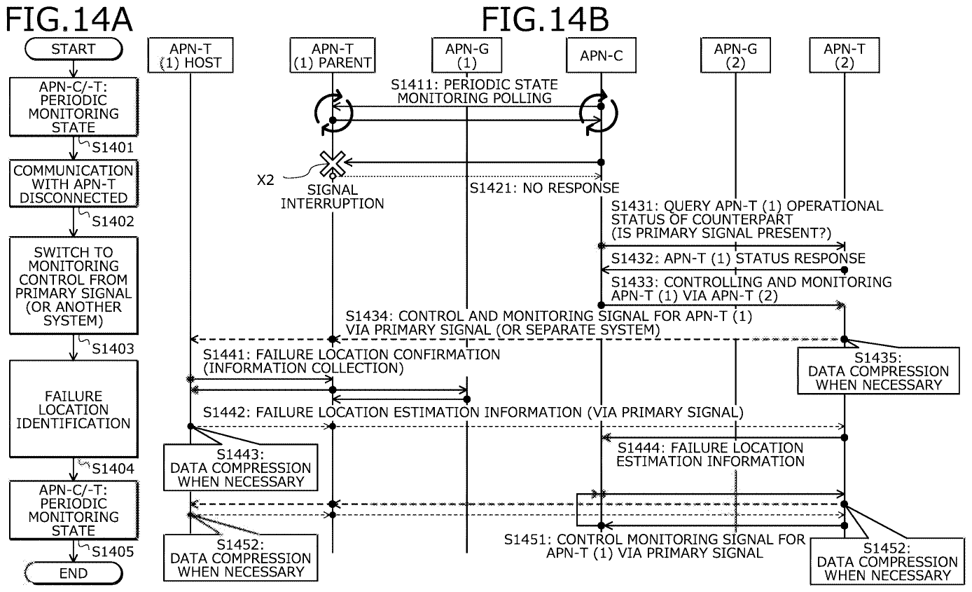

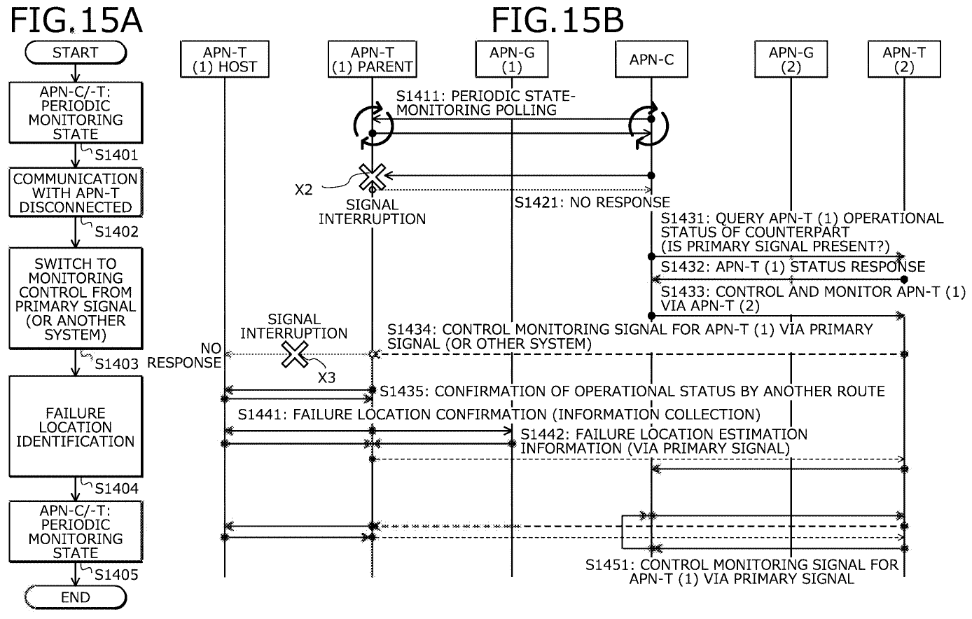

FIGS. 14A, 14B, 15A, and 15B 15 are diagrams depicting an example of a path switching process of a control signal when a failure of the control signal occurs. First, FIGS. 14A and 14B are explanatory diagrams of processing by the devices in the APN network when a failure of the control signal B depicted in FIG. 12 occurs (disconnection of the location X2) during operation after communication of the primary signal A. FIG. 14A is a flowchart depicting processing contents when the control signal is interrupted at the point X2, and FIG. 14B is a sequence diagram of information transmitted and received between the respective devices of the APN network corresponding to the respective processing contents depicted in FIG. 14A.

As depicted in FIG. 14A, during operation, the APN-C enters an APN-T periodic monitoring state using the control signal B (step S1401). Here, it is assumed that communication between the APN-C and the APN-T is interrupted (step S1402). In this case, the APN-C switches the transmission path of the control signal B to monitoring control from the primary signal A (or another system) (step S1403).

Then, the APN-C performs failure location identification (step S1404). Thereafter, the APN-C and the APN-Ts return to the periodic monitoring state of the control signal B (step S1405).

The processing of the devices will be described with reference to FIG. 14B. During operation, the APN-C performs periodic status monitoring polling on the APN-T(1) parent using the control signal B, and the APN-T(1) parent responds to the APN-C (step S1411). Here, it is assumed that control signal B between the APN-T(1) parent_and the APN-C is disconnected (disconnection at point X2 in FIG. 12). In this case, even when the APN-C performs periodic status monitoring polling on the APN-T(1) parent, the APN-T(1) parent_does not respond to the APN-C (step S1421).

In this case, the APN-C performs state confirmation (existence inquiry) of the APN-T(1) to the APN-T(2) which is the communications counterpart of the primary signal A transmission (step S1431). In the state depicted in FIG. 12, the primary signal A between the APN-T(1) and the APN-T(2) is communicable (present). Then, the APN-T(2) responds to the APN-C that the APN-T(1) is communicable (present) (step S1432).

Thus, the APN-C switches to control monitoring of the APN-T(1) using the control signal B via the APN-T(2) (step S1433). At this time, the APN-T(2) transmits a control monitoring signal (control signal B) for the APN-T(1) to the APN-T(1) via the primary signal A (or another system) (step S1434). In the example depicted in FIG. 12, the APN-T(2) superimposes the control monitoring signal (control signal B) on the primary signal A and transmits the primary signal A to the APN-T(1). At this time, the APN-T(2) compresses the control monitoring signal (control signal B) as necessary and superimposes the signal on the primary signal A (step S1435).

The APN-T(1) host that receives the control monitoring signal collects information for checking the failure location (step S1441). For example, the APN-T(2) host obtains information concerning the interruption location X2 by collecting information from the transit (intermediate relay) device (the APN-G(1) in FIG. 12) on the transmission path of the control signal B. Then, the APN-T(1) host superimposes failure location estimation information (control signal B) of the failure location X2 on the primary signal A, and transmits the primary signal A to the APN-T(2), which is the communications counterpart (step S1442). At this time, the APN-T(1) compresses data of the control signal B as necessary and superimposes the control signal B on the primary signal A (step S1443).

The APN-T(2) transmits the failure location estimation information to the APN-C by the control signal B (step S1444). As a result, the APN-C identifies the location X2 where the control signal B is interrupted. Thereafter, the APN-C transmits and receives the control monitoring signal (control signal B) with respect to the APN-T(1) through the transmission path (the APN-C to the APN-T(2) to the APN-T(1)) that avoids the interruption location X2 (step S1451). The APN-T(1) and the APN-T(2) compress the control monitoring signal (control signal B) as necessary and superimpose the signal on the primary signal A (step S1452).

Next, FIGS. 15A and 15B are explanatory diagrams of processing by devices on the APN network when the failure of the control signal B depicted in FIG. 13 occurs (disconnection at the locations X2 and X3) during operation after communication of the primary signal A. FIG. 15A is a flowchart depicting processing contents when interruption occurs at the points X2 and X3 of the control signal and FIG. 15B is a sequence diagram of information transmitted and received between the respective devices of the APN network corresponding to the processing contents depicted in FIG. 15A.

The entire process depicted in FIG. 15A is the same as that depicted in FIG. 14A. In the sequence diagram depicted in FIG. 15B, the same processes as those in FIG. 14B are denoted by the same reference numerals. FIG. 15B is different in that a point X3 where the control signal B is interrupted is added. Therefore, the control monitoring signal (control signal B) to the APN-T(2) to the APN-T(1) via the primary signal A at step S1434 is transmitted only to the APN-T(1) parent.

In this case, the APN-T(1) parent performs status confirmation (survival confirmation) concerning the control monitoring signal (control signal B) through another path (step S1435). In FIG. 13, direct access between the CPU 411 and the CPU 412 is interrupted, and the APN-T(1) parent_collects information for failure location confirmation (step S1441). In the example depicted in FIG. 15B, information is collected from the APN-G(1) and the APN-T(1) host.

As a result of the information collection, the APN-T(1) parent_checks whether the path (the CPU 411 to the L2SW 412 to the DSP 413) via the L2SW 414 is communicable (present). Thus, the APN-T(1) parent superimposes failure location estimation information (control signal B) of the failure location X3 on the primary signal A, and transmits the primary signal A to the APN-T(2), which is the communications counterpart (step S1442). Although not depicted in FIG. 15B, the APN-T(1) parent may compress control signal B as necessary and superimpose the compressed control signal on the primary signal A.

As a result, the APN-C identfies the location X3 in addition to the location X2 where the control signal B is interrupted. Thereafter, the APN-C transmits and receives the control monitoring signal (control signal B) with respect to the APN-T(1) through the transmission path (the APN-C to the APN-T(2) to the APN-T(1)), which avoids the interruption locations X2 and X3 (step S1451).

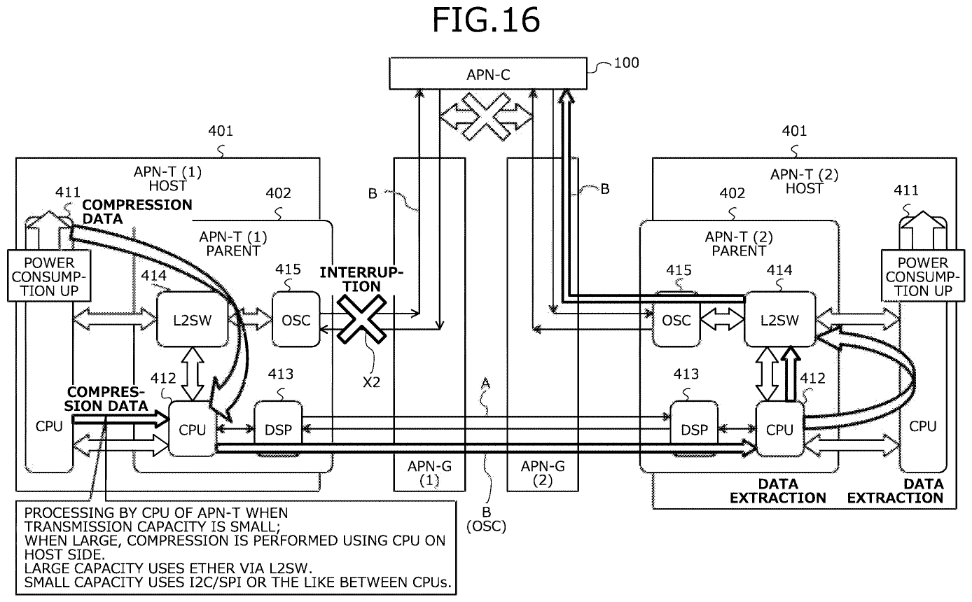

FIG. 16 is an explanatory diagram of an example of data compression of the control signal superimposed on the primary signal. In FIG. 16, the position X2 where the control signal B is interrupted and depicted in FIG. 12 will be described as an example. When the control signal B is not compressed, a transmission capacity corresponding to GbE at the maximum is necessary. Therefore, when the control signal B is superimposed on the OSC of the primary signal A and transmitted, it is desirable to perform data compression in order to prevent the delay of the control signal B and the band compression of the primary signal.

On the other hand, when data compression of the control signal B is performed, power consumption by the CPU 411 of the APN-T(1) host increases. Therefore, when the transmission capacity of the control signal B is small (for example, less than a threshold value), the APN-T(1) on the transmission side performs data compression processing of the control signal B at the CPU 412 of the APN-T(1) parent. On the other hand, when the transmission capacity of the control signal B is large (equal to or larger than the threshold value), the CPU 411 of the APN-T(1) host compresses the data of the control signal B. When the control signal B has a large capacity, the control signal B is transmitted to the APN-C via the L2SW 414 and an Ethernet (registered trademark). On the other hand, when the control signal B has a small capacity, the CPUs 411 and 412 communicate with each other using an Inter-Integrated Circuit/Serial Peripheral Interface (I2C)/(SPI) or the like.

Corresponding to the data compression of the control signal B performed by the components of the APN-T(1) on the transmission side, the components of the APN-T(2) on the reception side perform data decompression and transmit the control signal B to the APN-C.

In a normal state in which no failure occurs in transmission of the control signal B, the control signal B is transmitted to the APN-C through a transmission path (for example, Ethernet) different from that of the primary signal A without data compression, so that an increase in power consumption at the APN-T(1) and an influence of band compression of the primary signal A may be suppressed. In addition, only when a failure occurs in transmission of the control signal B, the control signal B is data-compressed, superimposed on the primary signal A, and transmitted, whereby the control signal B may be transmitted to the APN-C while suppressing an increase in power consumption at the APN-T(1) and an influence of band compression of the primary signal A. In addition, by switching the CPU that performs data compression according to the transmission capacity of the control signal B, it is possible to suppress an increase in power consumption of the CPU for data compression as much as possible.

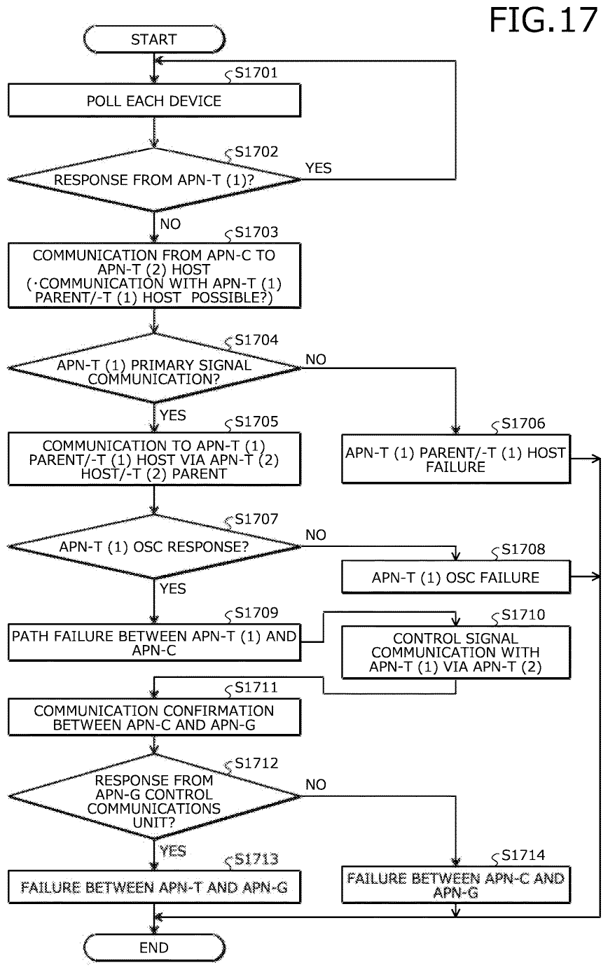

FIG. 17 is a flowchart depicting a processing example of the APN-C. The process depicted in FIG. 17 is performed by the controller 800 (CPU 801) of the APN-C. With reference to FIG. 17, a description will be given of an example of a process of identifying a fault (failure) location when the control signal B is interrupted and a process of transmitting the control signal B while avoiding the fault location.

First, the APN-C periodically polls the devices in the APN network for state monitoring (step S1701). First, the APN-C determines the presence or absence of a response to polling from the APN-T(1) (step S1702). As a result of the determination, when there is a response from the APN-T(1) (step S1702: YES), the APN-C returns to the process at step S1701 and performs polling on another device.

On the other hand, as a result of the determination, when there is no response from the APN-T(1) (step S1702: NO), the APN-C contacts the APN-T(2) host. The APN-C determines whether the APN-T(2) can communicate with the APN-T(1) parent/the APN-T(1) host (step S1703).

Then, the APN-C determines whether the response from the APN-T(2) is primary signal communication with the APN-T(1) (step S1704). When the APN-T(2) has primary signal communication with the APN-T(1) (step S1704: YES), the APN-C proceeds to the process at step S1705. On the other hand, when there is no primary signal communication between the APN-T(2) and the APN-T(1) (step S1704: NO), the APN-C proceeds to the process at step S1706.

At step S1705, the APN-C contacts the APN-T(1) parent_and the APN-T(1) host via the APN-T(2) host and the APN-T(2) parent (step S1705), and proceeds to the process at step S1707. At step S1706, the APN-C determines that the APN-T(1) parent or host has failed (step S1706), and ends the above processing.

At step S1707, the APN-C determines whether there is a response of the control signal B (OSC) from the APN-T(1). When there is a response of the control signal B (OSC) from the APN-T(1) (step S1707: YES), the APN-C proceeds to the process at step S1709. On the other hand, when there is no response of the control signal B (OSC) from the APN-T(1) (step S1707: NO), the APN-C determines that there is a failure in the transmission of the control signal B (OSC) from the APN-T(1) (step S1708), and ends the above processing.

At step S1709, the APN-C determines that there is a path failure of the control signal B (OSC) between the APN-T(1) and the APN-C (step S1709). The APN-C then communicates the control signal B to the APN-T(1) via the APN-T(2) (step S1710).

Next, the APN-C checks communication between the APN-C and the APN-G (step S1711). The APN-C determines the presence or absence of a control signal B response from the communications unit of the APN-G (step S1712). When there is a response of the control signal B from the APN-G (step S1712: YES), the APN-C proceeds to the process at step S1713. On the other hand, when there is no response of the control signal B from the APN-G (step S1712: NO), the APN-C proceeds to the process at step S1714.

At step S1713, the APN-C determines that the failure is between the APN-T and the APN-G (step S1713), and ends the above processing. At step S1714, the APN-C determines that the failure is between the APN-C and the APN-G (step S1714), and ends the above processing.

Through the above processing, the APN-C may identify lcations of failures that have occurred at devices (transmission paths) of the APN network. Further, the control signal B may be communicated to the devices while avoiding the failure portion (failure), and the transmission state of the APN network may be constantly monitored and controlled.

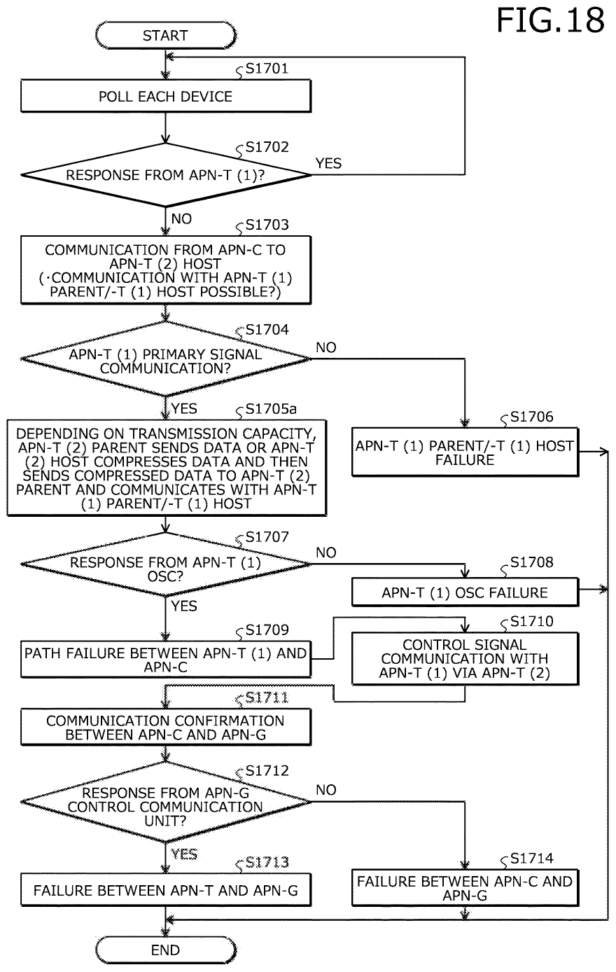

FIG. 18 is a flowchart depicting another example of processing by the APN-C. The process depicted in FIG. 18 is substantially the same as that depicted in FIG. 17, and only the process of compressing the data of the control signal B (step S1705a) is different. At step S1705a, the control signal B to be transmitted from the APN-C to the APN-T(1) is transmitted from the APN-T(2) parent or transmitted to the APN-T(2) after data is compressed at the APN-T(2) host according to the transfer capacity. The APN-T(2) then communicates the control signal B to the APN-T(1) parent/-T(1) host.

In the processing depicted in FIG. 18, the CPU 412 of the APN-T(1) parent performs a search (information collection) corresponding to FIGS. 14 and 15. the CPU 412 of the APN-T(1) parent outputs a LOG of the search result to the CPU 411 of the APN-T(1) host. the CPU 411 of the APN-T(1) host compresses the control signal B and transmits the compressed control signal B to the APN-C. The APN-C analyzes the received LOG and instructs the APN-T(1) host according to the control content.

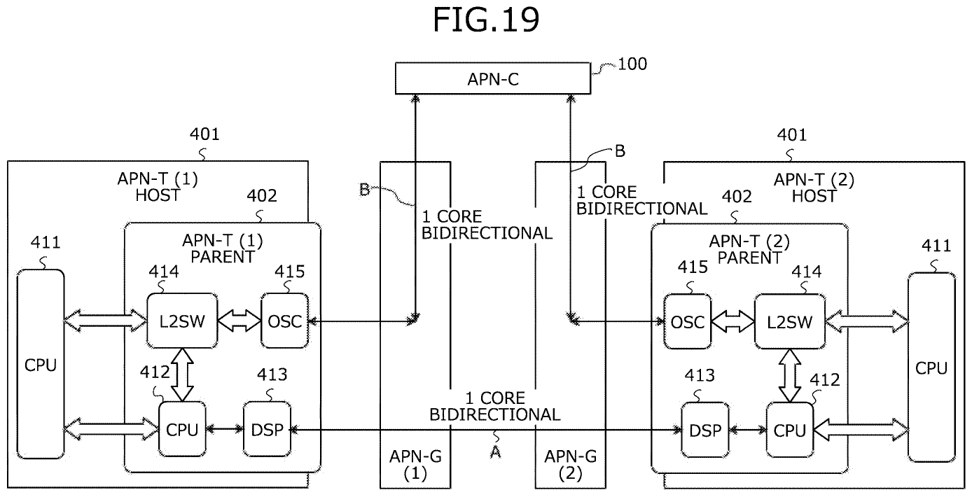

FIG. 19 is a diagram depicting another example of configuration of the transmission line according to the embodiment. As depicted in FIG. 19, the primary signal A may use a single-core bidirectional optical transmission path (optical fiber). Similarly, a single-core bidirectional optical transmission path may also be used for the path of the control signal B.

Hereinafter, configuration examples of the APN-Ts and switching control examples of the transmission paths of the control signal B when a failure occurs at the APN-Ts will be described.

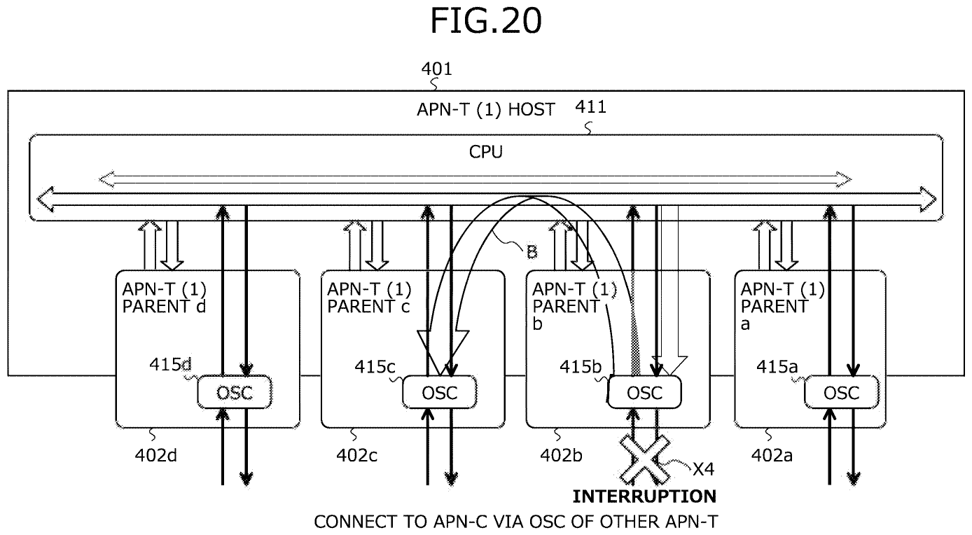

FIG. 20 is a diagram depicting a first configuration example of the APN-Ts. The APN-T(1) host 401 may accommodate multiple APN-T(1) parents: APN-T(1) parent_a (402a) to APN-T(1) parent_d (402d) in an internal slot. Although the internal configurations of the APN-T(1) parent_a (402a) to the APN-T(1) parent_d (402d) are omitted in FIG. 20, optical transmission using the primary signal A is possible for each.

The APN-T(1) parent_a (402a) to the APN-T(1) parent_d (402d) have OSC units 415 (415a to 415d), respectively, and may communicate the control signal B using OSC.

Here, it is assumed that communication of the control signal B using OSC by OSC unit 415b of the APN-T(1) parent_b (402b) is interrupted at location X4. In this case, under the control of the APN-C described above, path switching is performed to connect the control signal B of the APN-T(1) parent_b (402b) to the APN-C via the OSC unit 415c of another APN-T(1) parent (the APN-T(1) parent_c (402c)).

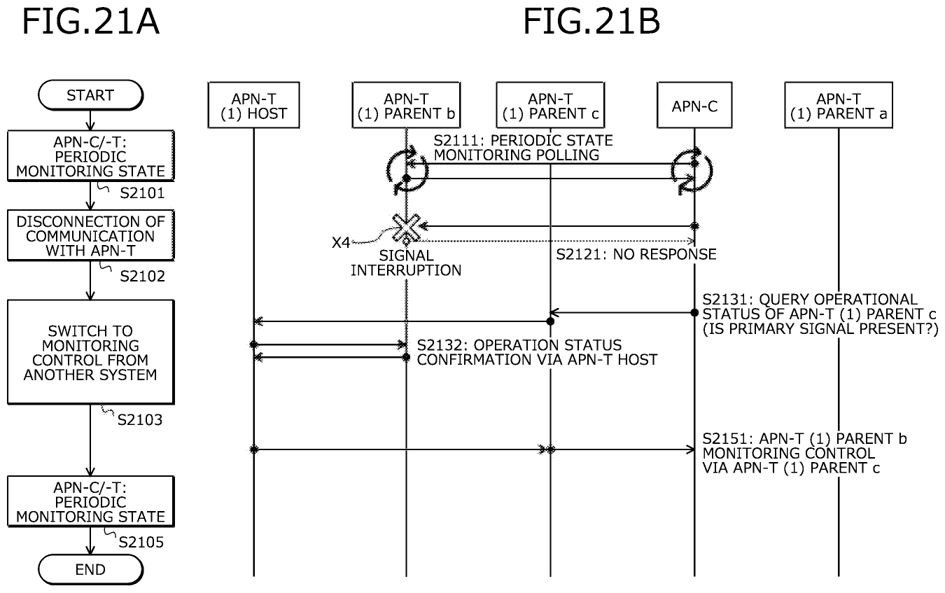

FIGS. 21A and 21B are diagrams depicting an example of a path switching process for a control signal, corresponding to the first APN-T configuration example. An example of the path switching process corresponding to the first configuration example depicted in FIG. 20 will be described with reference to FIGS. 21A and 21B. FIG. 21A is a flowchart depicting processing contents when interruption of the control signal occurs at the point X4, and FIG. 21B is a sequence diagram of information transmitted and received between the devices corresponding to the processing contents depicted in FIG. 21A.

As depicted in FIG. 21A, during operation, the APN-C enters a state of periodic monitoring of each parent of the APN-T(1) using the control signal B (step S2101). Here, when interruption (failure) occurs at location X4 in the first configuration example, communication between the APN-C and the APN-T(1) parent_b is interrupted (step S2102). In this case, the APN-C switches the transmission path of the control signal B to monitoring control from another APN-T(1) parent (the APN-T(1) parent_c) (step S2103). Thereafter, the APN-C and the APN-Ts return to the periodic monitoring state of the control signal B (step S2105).

The processes of the devices will be described with reference to FIG. 21B. The APN-C performs periodic state monitoring polling on each of the APN-T(1) parents_a to d using the control signal B (step S2111). Here, when the disconnected portion X4 occurs, the APN-T(1) parent_b does not respond to the APN-C even when the APN-C performs periodic state monitoring polling on the APN-T(1) parent_b (step S2121).

In this case, the APN-C checks the other APN-T(1) parents, for example, the APN-T(1) host, to check the state of the APN-T(1) parent_c (existence inquiry regarding presence of the primary signal A) (step S2131). In the state depicted in FIG. 20, it is assumed that the primary signal A of the APN-T(1) parent_c is in a communicable state. Thus, the APN-T(1) host checks the state of the APN-T(1) parent_b (step S2132).

Then, the APN-T(1) host transmits the control signal B of the APN-T(1) parent_b to the APN-C via the APN-T(1) parent_c. Thus, the APN-C receives the control signal B of the APN-T(1) parent_b via the APN-T(1) parent_c, and performs monitoring control of the APN-T(1) parent_b.

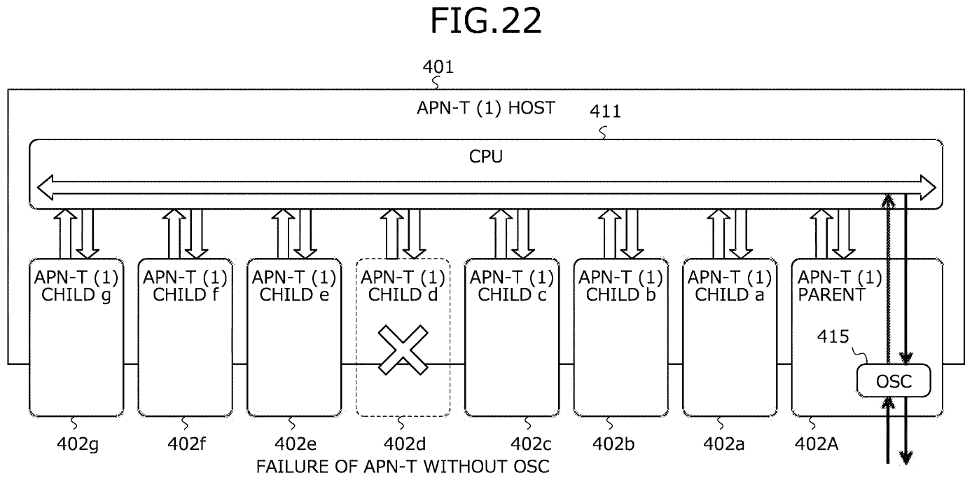

FIG. 22 is a diagram depicting a second configuration example of the APN-T. In the configuration example depicted in FIG. 22, the APN-T(1) host 401 accommodates the APN-T(1) parent (402A) and multiple APN-T(1) children (APN-T(1) child_a (402a) to the APN-T(1) child_g (402g) in an internal slot. Only the APN-T(1) parent (402A) has the OSC unit 415, and the APN-T(1) children have no OSC unit (not provided therein).

The CPU 411 of the APN-T(1) host 401 collects information of the APN-T(1) child_a (402a) to the APN-T(1) child_g (402g), and notifies the APN-C of the information via the APN-T(1) parent 402A.

Here, it is assumed that the APN-T(1) child_d (402d) has failed. In this case, the CPU 411 of the APN-T(1) host 401 notifies the APN-C, via the OSC unit 415 of the APN-T(1) parent 402A, that there is information that the APN-T(1) child_d (402d) cannot communicate due to a failure. However, in the second configuration example, since information of the APN-T(1) child_a (402a) to the APN-T(1) child_g (402g) is collected and notified to the APN-C, the processing load of the CPU 411 of the APN-T(1) host is large.

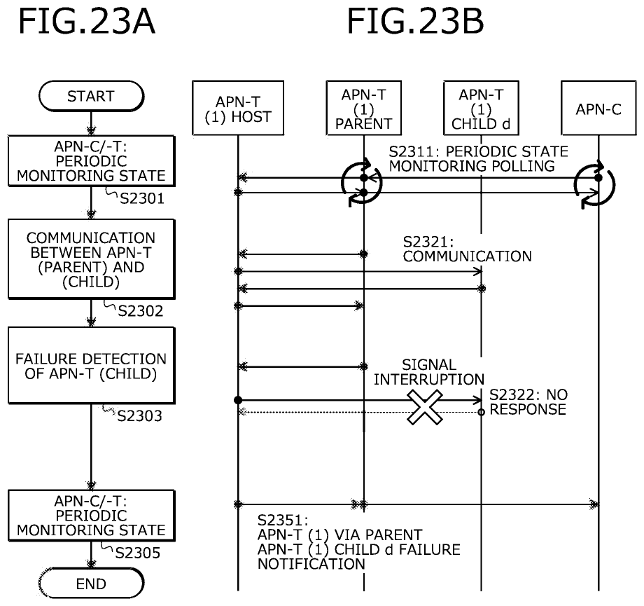

FIGS. 23A and 23B are diagrams depicting an example of a path switching process of a control signal corresponding to the second configuration example of the APN-T. An example of the path switching process corresponding to the second configuration example depicted in FIG. 22 will be described with reference to FIGS. 23A and 23B. FIG. 23A is a flowchart depicting processing contents at the time of failure of the APN-T(1) child_d (402d), and FIG. 23B is a sequence diagram of information transmitted and received between devices, corresponding to the processing contents depicted in FIG. 23A.

As depicted in FIG. 23A, during operation, the APN-C periodically monitors the parent and child states of the APN-T(1) by the control signal B (step S2301). Here, when a failure occurs at child_d in the second configuration example, communication between the APN-T(1) parent_and the APN-T(1) child_d is interrupted (step S2302). In this case, the APN-T(1) host detects the failure of the APN-T(1) child_d (step S2303). Then, the APN-T(1) host notifies the APN-C of the failure of the APN-T(1) child_d via the APN-T(1) parent, and the APN-C returns to the periodic state monitoring of the control signal B (step S2305).

The processes by the devices will be described with reference to FIG. 23B. The APN-C performs periodic state monitoring polling on the APN-T(1) host 401 using the control signal B (step S2311). At this time, the APN-T(1) host 401 communicates with the APN-C via the OSC unit 415 of the APN-T(1) parent 402A.

The APN-T(1) parent 402A communicates with multiple APN-T(1) children: the APN-T(1) child_a (402a) to the APN-T(1) child_g (402g) via the APN-T(1) host 401 (step S2321).

Here, it is assumed that the APN-T(1) child_d (402d) has failed. In this case, the communication signal between the APN-T(1) host 401 and the APN-T(1) child_d (402d) is interrupted, and the APN-T(1) child_d (402d) does not respond to the APN-T(1) host 401 (step S2322).

In this case, the APN-T(1) host 401 may notify the APN-C that the APN-T(1) child_d (402d) has failed via the OSC unit 415 of the APN-T(1) parent 402A (step S2351).

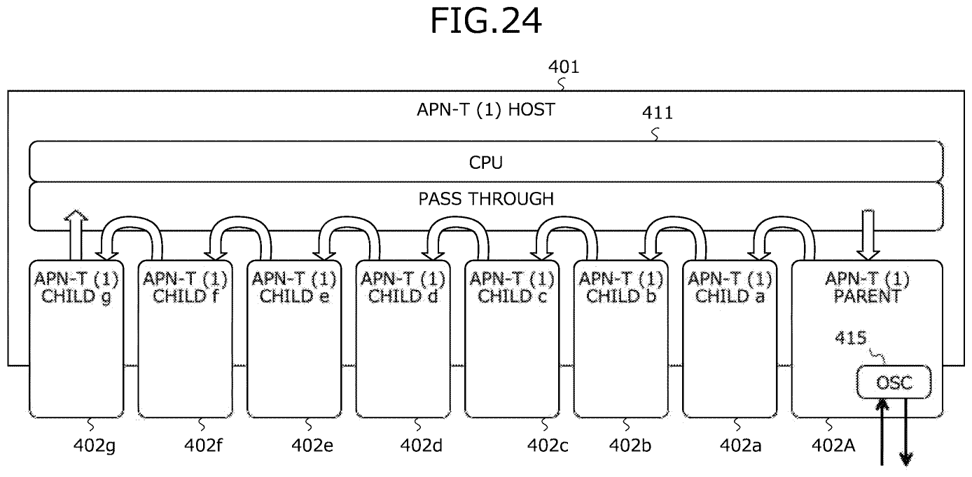

FIG. 24 is a diagram depicting a third configuration example of the APN-T. In the third configuration example, similar to the second configuration example (FIGS. 21A and 21B), the APN-T(1) host 401 accommodates the APN-T(1) parent (402A) and multiple APN-T(1) children (the APN-T(1) child_a (402a) to the APN-T(1) child_g (402g)) in an internal slot. Further, only the APN-T(1) parent (402A) has the OSC unit 415, and the APN-T(1) child has no OSC unit (not provided therein).

In the third configuration example, the APN-T(1) 402A and the APN-T(1) child_a (402a) to the APN-T(1) child_g (402g) are adjacently connected to each other through a pass-through connection (linked in a row). The APN-T(1) host 401 transmits data (control signal B) that has circulated through the APN-T(1) children to the APN-C via the OSC unit 415 of the APN-T(1) parent 402A. The APN-T(1) parent 402A outputs the data (control signal B) received from the APN-C by the OSC unit 415, to the adjacent APN-T(1) child_a (402a) by a pass-through connection.

Then, the APN-T(1) child_a (402a) to the APN-T(1) child_g (402g) extract (or add) only their own data and pass the other data to the APN-T(1) child adjacent thereto. According to the third configuration example, the CPU 411 of the APN-T(1) host 401 does not need to collect information of the APN-T(1) children_a to g, whereby the processing load may be reduced.

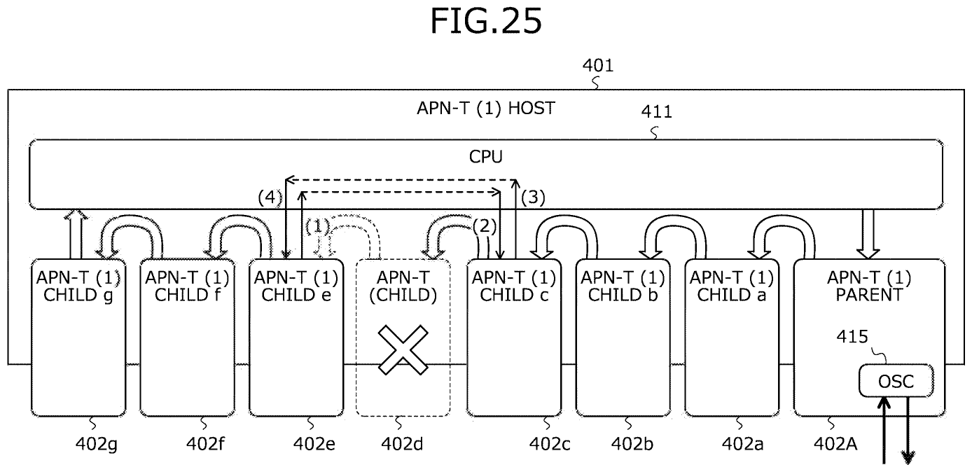

FIG. 25 is a diagram depicting a failure in the third configuration example of the APN-T. Each of the APN-T(1) child_a (402a) to the APN-T(1) child_g (402g) has an information path to the CPU 411 of the APN-T(1) host 401, but the information path is not normally used.

Here, when the APN-T(1) child_d (402d) fails, the following processes (1) to (4) are performed.
(1) The APN-T(1) child_e (402e) adjacent to the subsequent stage of pass-through connection of the APN-T(1) child_d notifies the CPU 411 of the APN-T(1) host 401.
(2) The APN-T(1) host 401 notifies the CPU 411 to transmit information of the APN-T(1) child_c (402c) adjacent to the previous stage of the pass-through connection of the APN-T(1) child_d.
(3) The APN-T(1) child_c (402c) transmits the control signal B to the CPU 411 of the APN-T(1) host 401.
(4) The APN-T(1) host 401 transmits the control signal B to the APN-T(1) child_e.

Through the above processes, the APN-T(1) host may transmit the information (control signal B) of the accommodated the APN-T(1) children_a to g to the APN-C, exclusive of the information of the child that cannot communicate due to a failure. Then, according to the third configuration example, even when multiple children having no OSC unit are provided and a failure occurs at a child, information of each normal child may be transmitted to the APN-C without increasing the processing load of the CPU.

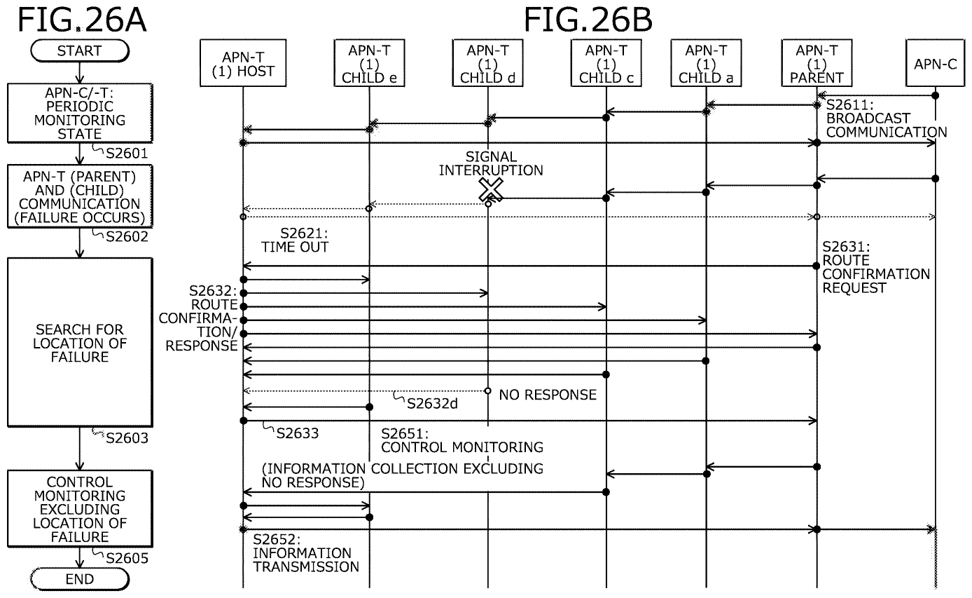

FIGS. 26A and 26B are diagrams depicting an example of a path switching process of a control signal corresponding to the third configuration example of the APN-T. An example of the path switching process corresponding to the third configuration example depicted in FIG. 25 will be described with reference to FIGS. 26A and 26B. FIG. 26A is a flowchart depicting processing contents at the time of failure of the APN-T(1) child_d (402d), and FIG. 26B is a sequence diagram of information transmitted and received between devices corresponding to the processing contents depicted in FIG. 26A.

As depicted in FIG. 26A, during operation, the APN-C periodically monitors the parent and child states of the APN-T(1) by the control signal B (step S2601). Here, when a failure occurs in the APN-T(1) child_d in the third configuration example, a communication failure occurs between the APN-T(1) parent_and the APN-T(1) child_d (step S2602). In this case, the APN-T(1) host searches for a failure occurrence location (step S2603). Then, the APN-T(1) host transmits state monitoring information (control signal B) to the APN-C, excluding the failure occurrence location (child) (step S2605).

The processes by the devices will be described with reference to FIG. 23B. In FIG. 23B, some (APN-T(1) child_b and APN-T(1) child_g) of the APN-T(1) children_a to g are omitted for convenience. Each time the APN-C performs the periodic state monitoring (polling) using the control signal B, the APN-T parent circulates the APN-T(1) children_a to g connected through the pass-through connection, returns to the APN-T parent, and performs communication for collecting information (step S2611).

Here, when the APN-T(1) child_d fails, communication circulation at the APN-T(1) child_e (402e) and subsequent APN-T(1) childern downstream from the APN-T(1) child_d cannot be performed, and the APN-T host 401 times out due to signal interruption. The APN-T(1) host notifies the APN-C of timeout information (control signal B) via the APN-T(1) (step S2621).

Then, the APN-T(1) parent requests the APN-T(1) host to perform a path check to search for a failure occurrence location (step S2631). The APN-T(1) host outputs a path confirmation signal to the APN-T(1) children_a to g (step S2632). The APN-T(1) children_a to g respond to the APN-T(1) host regarding the path confirmation.

Here, the APN-T(1) child_d cannot respond to the APN-T(1) host due to the failure (step S2632d). Thus, the APN-T(1) host outputs to the APN-T(1) parent, information (control signal B) indicating that a failure has been determined to have occurred at the APN-T(1) child_d (step S2633).

Thereafter, the parent of the APN-T(1) collects the information concerning each of the APN-T(1) children_a to g through the circulation path (see FIG. 25) exclusive of the child d of the APN-T(1) which is the failure occurrence location (step S2651). The APN-T(1) host transmits the collected information (control signal B) of each of the APN-T(1) children_a to g (excluding that of the APN-T(1) child d) to the APN-C, via the OSC unit 415 of the APN-T(1) parent (step S2652). Thereafter, the APN-C performs monitoring control on the parent and the APN-T(1) children (a to g, exclusive of the APN-T(1) child d) of the APN-T(1).

Hereinafter, a connection configuration example of each of the APN-T and the APN-G and an example of a switching process of the transmission path of the control signal B when a failure occurs in the APN-T will be described.

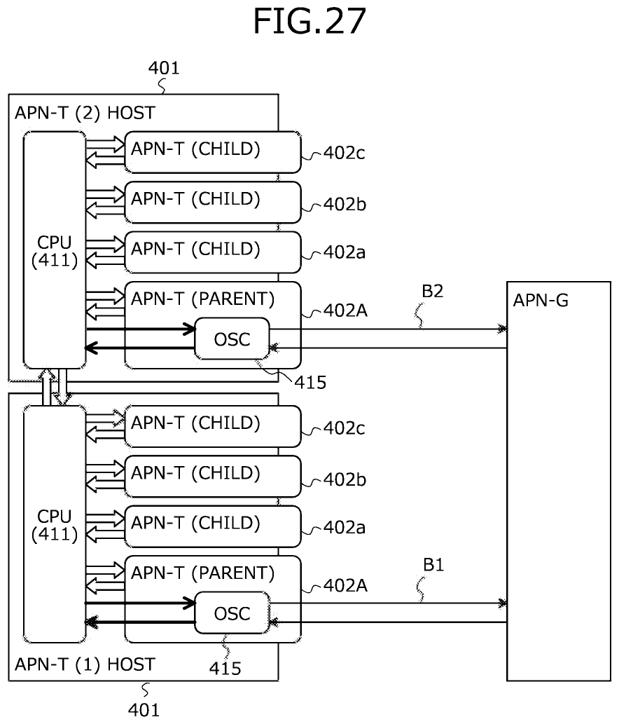

FIG. 27 is a diagram depicting a first connection configuration example of multiple APN-Ts and an APN-G. In the first connection configuration example depicted in FIG. 27, two hosts (the APN-T(1) host and the APN-T(2) host (401)) are connected to one APN-G in the transmission path of the control signal B.

The APN-T(1) host and the APN-T(2) host (401) each accommodate one parent 402A and multiple children 402a to 402c. The APN-T(1) host and the APN-T(2) host (401) each transmit information (control signal B) concnering the children 402a to 402c to the APN-G via the OSC unit 415 of parent 402A, and transmit the information to the APN-C (not depicted).

From the viewpoint of the APN-G, multiple (two systems of) control signals B are transmitted to the APN-T(1) host and the APN-T(2) host (401). In this case, the control signal B1 between the APN-G and the APN-T(1) and the control signal B2 between the APN-G and the APN-T(2) have different wavelengths (wavelengths of OSC signals). In addition, when the control signals B1 and B2 have the same wavelength, the format is set such that the APN-T(1) and the APN-T(2) may be identified.

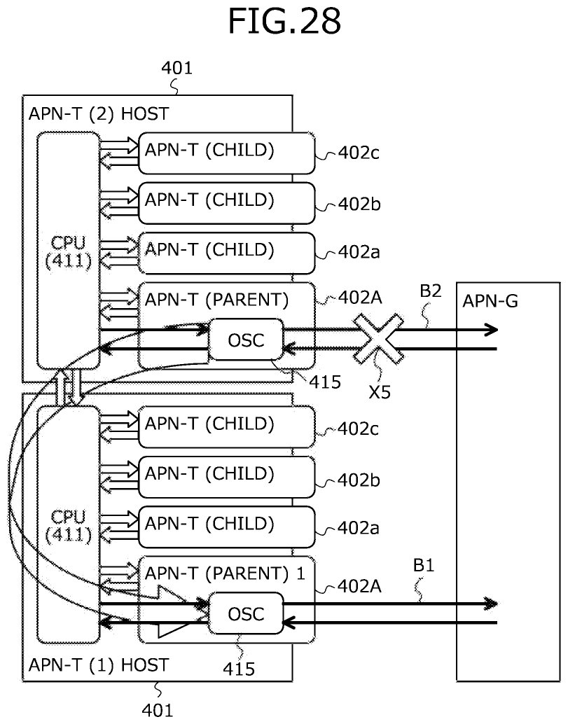

FIG. 28 is a diagram depicting an example of a path switching process at the time of a failure in the first connection configuration example of multiple APN-Ts and an APN-G. In the first connection configuration example depicted in FIG. 27, communication is established between the APN-T(1) host and the APN-T(2) host via the respective CPUs 411 thereof.

Here, it is assumed that a failure occurs at a location X5 of the APN-T(2). In this case, the APN-T(2) host transfers the control signal B2 for communication with the APN-G (the APN-C) to the APN-T(1) host by inter-CPU communication. Then, the APN-T(1) host may transmit the control signal B2 from the OSC unit 415 of the APN-T(1) to the APN-G together with the control signal B1.

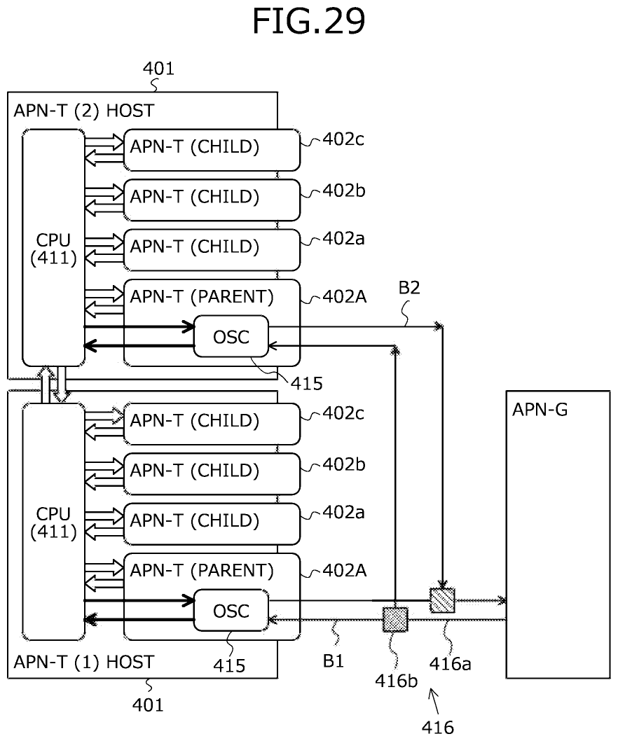

FIG. 29 is a diagram depicting a second connection configuration example of multiple APN-Ts and an APN-G. In the example depicted in FIG. 29, for the transmission path of the control signal B, two hosts (the APN-T(1) host and the APN-T(2) host (401)) are connected to one APN-G. As depicted in FIG. 4, the multiplexer/demultiplexer 416 wavelength-multiplexes the control signal B into the primary signal A.

In the second connection configuration example, the wavelengths of the control signals B1 and B2 cannot be simply set to the same wavelength. For example, one of the wavelengths of the two control signals B1 and B2 is set to the OSC wavelength (1511 nm), and the other is set to a different wavelength other than the OSC wavelength. In addition, an OSC signal of a single OSC wavelength may be transmitted using various formats such as assigning an identifier capable of identifying the control signals B1 and B2.

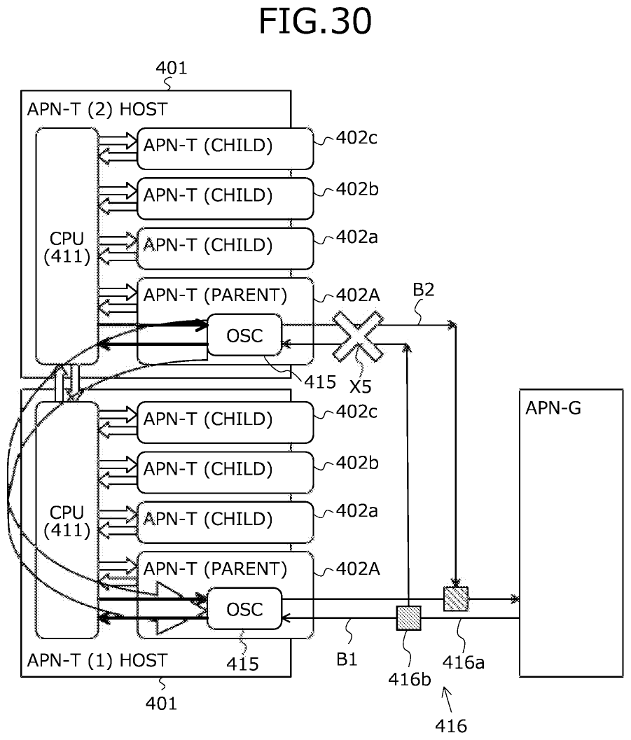

FIG. 30 is a diagram depicting an example of a path switching process at the time of a failure in the second connection configuration example of multiple APN-Ts and an APN-G. In the second connection configuration example as well, similar to the first connection configuration example, communication is established between the APN-T(1) host and the APN-T(2) host via the respective CPUs 411 thereof.

Here, it is assumed that a failure occurs at the location X5 of the APN-T(2). In this case, the APN-T(2) host transfers the control signal B2 for communication with the APN-G (the APN-C) to the APN-T(1) host by inter-CPU communication. Then, the APN-T(1) host transmits the control signal B2 from the OSC unit 415 of the APN-T(1) to the APN-G together with control signal B1. The control signals B1 and B2 make the wavelengths of the OSCs different from each other. Alternatively, the control signals B1 and B2 may be transmitted in an identifiable OSC signal format.

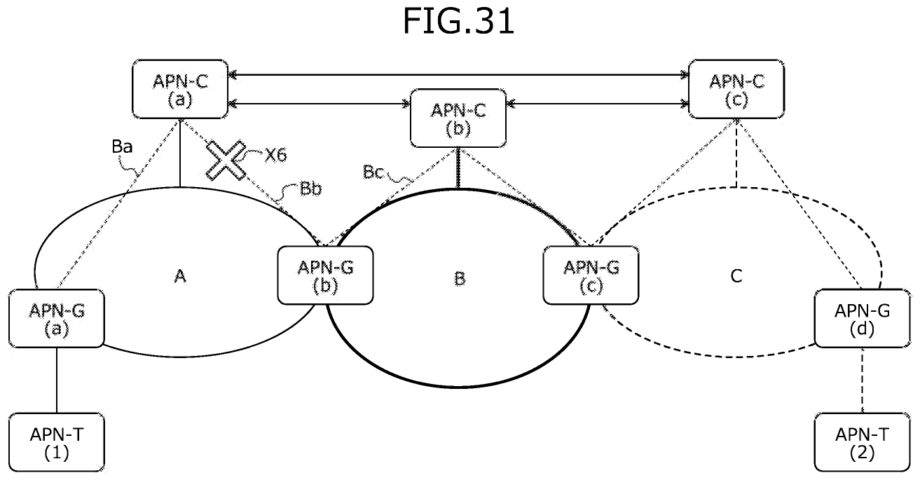

FIG. 31 is a configuration example of another APN network and example of a path switching process at the time of failure. In the APN network depicted in FIG. 31, multiple (three) the APN-C(a) to the APN-C(c) manage and control the ring APN networks A, B, and C, respectively.

The APN-C(a) to the APN-C(c) transmit control information B to other adjacent APN-Cs. The APN-G(b) disposed on the APN network (transmission path) may switch transmission of a primary signal between the APN network A and the APN network B. The APN-G(c) may switch transmission of a primary signal between the APN network B and the APN network C.

In the example depicted in FIG. 31, the APN-T(1) and the APN-T(2) that are E2E connected transmit primary signals via the APN-G(b) and the APN-G(c) of APN networks A, B, and C.

Each of the APN-C(a) to the APN-C(c) monitors and controls the states of the device disposed in the subordinate APN networks A to C and the transmission state of the primary signal based on the control signal B.

Here, it is assumed that a failure occurs at a location X6 between the APN-C(a) and the APN-G(b) and the control signal Bb cannot be transmitted. In this case, the APN-G(b) superimposes the control signal Bb on the primary signal of the APN network A and transfers the primary signal to the APN-G(a), and the APN-G(a) may transmit the control signal Bb together with the control signal Ba to the APN-C(a). In addition, the APN-G(b) may transfer the control signal Bb to the APN-C(b) together with the control signal Bc, and the APN-C(b) may transfer the control signal Bb to the APN-C(a).

Thus, even in APN networks of various configurations, a control signal may be transmitted to the APN-C via the devices on the APN network.

The controller 800 (see FIG. 8) of the optical communications controller (the APN-C) has been described using the CPU 801 as an example. However, the present disclosure is not limited hereto, and a dedicated DSP, ASIC, or FPGA that performs high-speed signal processing may also be used. ASIC is an abbreviation for Application Specific Integrated Circuit, and FPGA is an abbreviation for Field Programmable Gate Array.

The optical communications controller (the APN-C) according to the embodiment described above manages and controls multiple devices under the control of the optical transmission network. The APN-C includes a controller that obtains through a transmission path different from a transmission path of the primary signal, a control signal including states of devices and states of transmission paths, searches for an alternative communicable path when the control signal cannot be obtained, obtains the control signal using the alternative path, and continues management control of the optical transmission network. As a result, the stability and availability of the APN network system may be improved, and service interruption in the event of a failure may be minimized.

In the APN-C according to the embodiment, when the controller obtains a control signal including a failure occurrence location from any of the devices, the controller searches for an alternative path that bypasses the path in which the failure has occurred and continues communication of the control signal with the device in which the failure has occurred. Accordingly, the APN-C may always obtain the control signal, and may manage and control the APN network while ensuring stability and availability.

The APN-C according to the embodiment searches for a failure occurrence location on a different transmission path when the controller cannot obtain the control signal. As a result, the APN-C may immediately detect the failure occurrence location of the APN network, and may minimize service interruption at the time of a failure.

The controller of the APN-C according to the embodiment includes the alternative path as a part of the transmission path of the primary signal. Accordingly, the APN-C may obtain a control signal through various transmission paths, and may immediately detect an occurrence of a failure in the devices of the APN network to minimize service interruption at the time of a failure.

In the APN-C according to the embodiment, the controller checks the state of each device at the time of searching for an alternative path, and sets a transmission path that bypasses a path in which a failure has occurred by transmitting a control signal via a communicable device. Thus, the APN-C may obtain the control signal via the communicable device, and may immediately detect an occurrence of a failure in each device of the APN network to minimize service interruption at the time of a failure.

An optical communications system according to an embodiment includes multiple devices (the APN-T and the APN-Gs) under an APN network, and an optical communications controller APN-C that manages and controls the multiple devices. The APN-C includes a controller that obtains through a transmission path different from a transmission path of the primary signal, a control signal including a state of each device and states of transmission paths, searches for an alternative communicable path when the control signal cannot be obtained, obtains the control signal using the alternative path, and continues management and control of the optical transmission network. As a result, the stability and availability of the APN network system may be improved, and service interruption in the event of a failure may be minimized.

In the optical communications system according to the embodiment, a control signal between the APN-C and each device includes a transmission path of an electrical signal or an optical signal that directly connects the APN-C and each device. As a result, the APN-C may immediately detect the occurrence of a failure in each device of the APN network and minimize service interruption at the time of a failure by obtaining a control signal not only as a primary signal (optical signal) but also as an electric signal such as Ethernet between the APN-C and each device.

Each device of the optical communications system according to the embodiment includes a monitoring gateway APN-G disposed on the APN network and a pair of optical transceivers APN-Ts connected via the APN-G and configured to transmit the primary signal. As a result, the APN-C may obtain the control signal via any one of the APN-Ts and the APN-Gs of the APN network, and may always obtain the control signal regardless of the failure occurrence location, and may minimize service interruption at the time of a failure.

The APN-T of the optical communications system according to the embodiment includes a controller that wavelength-multiplexes the control signal on the primary signal when the alternative path of the control signal with the APN-C includes the transmission path of the primary signal. As a result, the APN-C may use the path of the primary signal as a part of the transmission path of the control signal, and may always obtain the control signal regardless of the failure occurrence location.

The controller of the APN-T of the optical communications system according to the embodiment performs data compression on the control signal. Accordingly, when the primary signal is used in a part of the transmission path of the control signal, it is possible to perform transmission in which delay of the control signal and pressure on the band of the primary signal are prevented.

In the optical communications system according to the embodiment, the optical transmission path on the transmission path of the control signal may perform single-core bidirectional communication. As described, the control signal may be transmitted through various optical transmission paths.

In the APN-T of the optical communications system according to the embodiment, multiple modules may be inserted into and removed from the host, and when a module fails, the host notifies the optical communications controller of information of the failed module by a control signal. Thus, the APN-T may notify the APN-C of a failure in a module unit.

The modules of the APN-T of the optical communications system according to the embodiment include a parent module having an OSC unit capable of transmitting an OSC signal and multiple child modules (402b to 402d) not having an OSC unit. When a child module fails, the host notifies the optical communications controller of information concerning the failed module by a control signal via the OSC unit of the parent module. As described, even when the host has parent and child modules and a child module that cannot transmit an OSC signal fails, a control signal including the failure may be notified to the APN-C using the OSC signal of the parent module.

In addition, the modules of the APN-T of the optical communications system according to the embodiment circulate and transfer the control signal between the adjacent parent module and the child modules by a pass-through connection. In the APN-T, when a child module fails, the host transfers a control signal through a transfer path avoiding the failed child module, and the host notifies the optical communications controller of information concerning the failed module by a control signal via the OSC unit of the parent module. As described, by connecting multiple parent-child modules in a pass-through manner and transferring control signals in a circulating manner, the processing load on the host may be reduced.

Further, the optical communications system according to the embodiment may have a configuration in which multiple APN-Ts (APN-T(1) and the APN-T(2)) are connected to an APN-G. When a failure occurs in transmission of the control signal between one of the APN-Ts (the APN-T(2)) and the APN-G, the one APN-T (the APN-T(2)) transfers the control signal by communication with the other the APN-T(1), and notifies the APN-C of information concerning the occurrence of the failure in the one APN-T (the APN-T(2)) by a control signal through the APN-G via the other (the APN-T(1)). Thus, even in a configuration in which multiple APN-Ts (the APN-T(1) and the APN-T(2)) are connected to the APN-G, the APN-C may be notified of failure occurrence in the APN-Ts (the APN-T(1) and the APN-T(2)) via the APN-G.

In addition, in the optical communications system according to the embodiment, when the control signals B1 and B2 between the APN-G and the APN-Ts are wavelength-multiplexed onto the primary signal, the APN-Ts perform communication of the control signals at the wavelength of the OSC signal different for each optical the APN-T or perform communication in which the APN-T may be identified by the OSC signal of a single wavelength. Accordingly, the control signal between the APN-Ts and the APN-G may be transmitted so that the APN-Ts may be identified using the OSC signal of the primary signal.

In the optical communications system according to the embodiment, multiple APN networks are managed by multiple corresponding the APN-Cs. In this system configuration, when a failure occurs in a transmission path of a control signal in one APN network A, a control signal including failure occurrence information is transferred to the APN-C of the APN network A through an alternative path passing through the APN-C of another APN network B. As described, the control signal may be transferred across multiple APN networks, and the control signal may be transferred between various the APN networks.

According to the embodiment, it is possible to improve the stability and availability of the system of the optical transmission network and minimize service interruption at the time of a failure.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An optical communications controller for managing and controlling a plurality of devices under control of an optical transmission network, the optical communications controller comprising a controller configured to:
obtain through a different transmission path different from a transmission path of a primary signal, a control signal including a state of each of the plurality of devices and a transmission path state;
search for an alternative communicable path and obtain the control signal using the alternative path when the control signal cannot be obtained; and
continue management control of the optical transmission network.

2. The optical communications controller according to claim 1, wherein the controller, when obtaining from any one of the plurality of devices, the control signal including a failure occurrence point, finds the alternative path that bypasses a path in which a failure has occurred, and continues communication of the control signal with a device that is among the plurality of devices and where the failure has occurred.

3. The optical communications controller according to claim 1, wherein the controller searches for a failure occurrence point on the different transmission path when the control signal cannot be obtained.

4. The optical communications controller according to claim 1, wherein
the alternative path includes a part of the transmission path of the primary signal, and
the controller uses the alternative path for communication.

5. The optical communications controller according to claim 1, wherein the controller checks the state of each of the plurality of devices when searching for the alternative path, and sets a transmission path through a communicable device of the plurality of devices and bypasses a path in which a failure has occurred.

6. An optical communications system, comprising:
a plurality of devices under control of an optical transmission network; and
an optical communications controller for managing and controlling the plurality of devices, wherein
the optical communications controller has a controller configured to:
obtain, through a different transmission path different from a transmission path of a primary signal, a control signal including a state of each of the plurality of devices and a transmission path state;
search for an alternative communicable path and obtain the control signal using the alternative path when the control signal cannot be obtained; and
continue management and control of the optical transmission network.

7. The optical communications system according to claim 6, wherein the control signal between the optical communications controller and the each of the plurality of devices includes a transmission path of an electric signal or an optical signal directly coupling the optical communications controller and the each of the plurality of devices.

8. The optical communications system according to claim 6, wherein the plurality of devices includes:
a monitoring gateway disposed on the optical transmission network, and
a pair of optical transceivers for transmitting the primary signal and coupled via the monitoring gateway.

9. The optical communications system according to claim 8, wherein each of the pair of transceivers has a controller configured to perform control to wavelength-multiplex the control signal onto the primary signal when the alternative path of the control signal between the each of the pair of transceivers and the optical communications controller includes the transmission path of the primary signal.

10. The optical communications system according to claim 8, wherein each of the pair of transceivers has a controller configured to perform control to data-compress the control signal.

11. The optical communications system according to claim 6, wherein an optical transmission path on a transmission path of the control signal performs single-core bidirectional communication.

12. The optical communications system according to claim 8, wherein
in each of the pair of optical transceivers, a plurality of modules are insertable into and removable from a host, and
when one of the plurality of modules fails, the host notifies the optical communications controller of information concerning the failed one of the plurality of modules, by the control signal.

13. The optical communications system according to claim 12, wherein
the plurality of modules include:
a parent module having an OSC unit configured to transmit an OSC signal, and
a plurality of child modules free of the OSC unit, and
the host, when the one of the plurality of child modules fails, notifies the optical communications controller of the information concerning the failed one of the plurality of child modules, by the control signal via the OSC unit of the parent module.

14. The optical communications system according to claim 13, wherein
the plurality of modules transfer the control signal between the parent module and the plurality of child modules adjacent to each other, by circulating the control signal through a pass-through connection therebetween, and
the host, when the one of the plurality of child module fails, transfers the control signal through a transfer path avoiding the failed one of the plurality of modules, and notifies the optical communications controller of the information concerning the failed one of the plurality of modules, by the control signal through the OSC unit of the parent module.

15. The optical communications system according to claim 8, wherein
a plurality of optical transceivers is connected to the monitoring gateway, and
when a failure occurs in transmission of the control signal between one of the plurality of optical transceivers and the monitoring gateway, the one of the plurality of optical transceivers transfers the control signal by communication between others of the plurality of optical transceivers, and notifies the optical communications controller of the information concerning occurrence of the failure at the one of the plurality of optical transceivers, by the control signal through the monitoring gateway via the others of the plurality of optical transceivers.

16. The optical communications system according to claim 15, wherein
when the control signal of more than one of the plurality of optical transceivers is to be wavelength-multiplexed on the primary signal and communicated with the monitoring gateway, each the plurality of optical transceivers communicates the control signal thereof by an OSC signal of a wavelength different from that of others of the plurality of optical transceivers or by an OSC signal identifying the each of the plurality of optical transceivers and of a same wavelength as the others of the plurality of optical transceivers.

17. The optical communications system according to claim 6, further comprising:
a plurality of the optical transmission network; and
a plurality of the optical communications controller corresponding to and managing the plurality of the optical transmission network, wherein
when a failure occurs in a transmission path of the control signal in one of the plurality of the optical transmission network, the control signal including information concerning occurrence of the failure is transferred to a corresponding one of the plurality of the optical communications controller through the alternative path, the corresponding one of the plurality of the optical communications controller corresponding to the one of the plurality of the optical transmission network, and the alternative path passing through others of the plurality of the optical communications controller excluding the corresponding one of the plurality of the optical communications controller.
